(19) United States
(12) Patent Application Publication
(10) Pub. No.: US 2008/0138634 A1
(43) Pub. Date: Jun. 12, 2008

(54) Polysiloxane based in situ polymer blends-compositions, articles and methods of preparation thereof

(75) Inventors: Joseph P. Morris, Annapolis, MD (US); Samuel P. Gido, Hadley, MA (US); Jimmy W. Mays, Knoxville, TN (US)

Correspondence Address: EDWARDS ANGELL PALMER & DODGE LLP, P.O. BOX 55874, BOSTON, MA, 02205, US

(73) Assignee: FujiFilm Hunt Smart Surfaces, LLC

(21) Appl. No.: 11/880,987

(22) Filed: Jul. 25, 2007

Related U.S. Application Data
(60) Provisional application No. 60/832,971, filed on Jul. 25, 2006.
(60) Provisional application No. 60/832,972, filed on Jul. 25, 2006.

(51) Int. Cl. C09D 5/14; C08L 83/10

(52) U.S. Cl. 428/447; 525/474; 525/100; 525/104; 525/106; 427/407.1

(57) ABSTRACT

Stable blend compositions composed of mixtures of polysiloxane(s) and organic polymer(s) are claimed. These polymer blends are white and opaque indicating the presence of phase separation on the micron scale. Such blends can be stored for long periods of time (years) without exhibiting evidence of macroscopic phase separation. These stable blends are achieved without substantial crosslinking as evidenced by the fact that the polymer blend is readily dissolved in a suitable organic solvent for molecular weight characterization. The stable blends of the present invention have particular utility as fouling release coatings for marine applications.

### RELATED U.S. PATENT APPLICATIONS

This application for U.S. patent relates and claims priority to U.S. provisional application, which was filed on Jul. 25, 2006 and assigned Provisional Ser. No. 60/832,971 and is entitled Polysiloxane-Based In-situ Polymer Blends. This application for U.S. patent also relates and claims priority to U.S. provisional application, which was filed on Jul. 25, 2006 and assigned Provisional Ser. No. 60/832,972 and is entitled Method for Preparing Polysiloxane-Based In-situ Polymer Blends.

### U.S. PATENT APPLICATION

This application for U.S. patent is filed as a utility application under U.S.C., Title 35, §111(a).

### INCORPORATION BY REFERENCE

Each of the applications and patents cited in this text, as well as each document or reference cited in each of the applications and patents (including during the prosecution of each issued patent; “application cited documents”), and each of the PCT and foreign applications or patents corresponding to and/or paragraphing priority from any of these applications and patents, and each of the documents cited or referenced in each of the application cited documents, are hereby expressly incorporated herein by reference. More generally, documents or references are cited in this text, either in a Reference List, or in the text itself; and, each of these documents or references (“herein-cited references”), as well as each document or reference cited in each of the herein-cited references (including any manufacturer's specifications, instructions, etc.), is hereby expressly incorporated herein by reference.

### BACKGROUND

Objects, such as boats, ships, buoys, water intake and discharge pipes, submerged in freshwater or seawater become infested with aquatic organisms such as barnacles, mussels, tube worms, and algae. The presence of “marine fouling” causes serious problems, including loss of aesthetic appeal, decrease in efficiency of operation, etc. Thus, it has become customary to coat the surfaces of such objects with antifouling paints.

Until now, these antifouling paints have usually incorporated toxic tin or copper compounds. The tin-based coatings are virtually banned due to environmental concerns. Copper-based coatings are used extensively at present, but they do not work as well as tin, have shorter lifetimes, and are under increasing pressure due to environmental concerns.

Polysiloxanes or silicones, specifically poly(dimethylsiloxane) (PDMS), have recently been investigated as anti-fouling or more appropriately fouling release coatings for marine applications. These materials have inherent release properties that minimize fouling without the use of toxic metals. Some fouling control coatings based on silicone elastomers have been known since the early 1970's. For instance, silicone-based formulations are disclosed in U.S. Pat. Nos. 4,025,693; 4,080,190; 4,227,929; and others. Also, Japanese patent application 96830/76 discloses an antifouling paint that uses a mixture of a silicone oil and an oligomer-like silicone rubber having terminal hydroxyl groups. Unfortunately, silicones have been hindered by problems with durability and difficulty in forming strong bonds between the silicone layer and the substrate.

The present invention describes the preparation of stable polymer blends containing silicones. These blends may be used to form coatings that have good anti-fouling properties and are much tougher and more durable than silicone release coatings such as RTV11 which is a silicone elastomer provided with a separate dibutyl tin dilaurate catalyst that is commercially available from GE Silicones of Waterford, N.Y. Thus, these blends may be used as tough anti-fouling topcoats or they may be used as bonding layers or tie coat layers for bonding to silicone topcoats and providing improved toughness and enhanced adhesion resistance.

### SUMMARY OF THE INVENTION

In one aspect, the invention encompasses a fouling release tie coat polymer blend comprising at least one polysiloxane polymer and one organic polymer wherein said organic polymer is comprised of monomers that polymerize to single chain polymers and wherein said organic polymer is not comprised of crosslinking multifunctional monomers.

In another embodiment, the tie coat polymer blend is comprised of polymers having typical weight-average molecular weights of from about 50,000 to about 500,000 and more preferably from about 120,000 to about 160,000.

In still another embodiment, the polysiloxane polymer of the tie coat polymer blend has the repeating unit formula

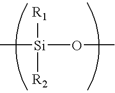

wherein R₁ and R₂ are independently substituted or unsubstituted C1-C3 alkyl, or substituted or unsubstituted aryl, wherein said substituents, if present, are chosen from cyano, halogen or another group which does not provide another linking functionality.

In yet another embodiment, at least one terminal end of the polysiloxane polymer has at a terminal reactive group; preferably the terminal reactive group is a hydroxyl group, an alkoxy group, an aryloxy group, an amino group, an amido group, a halogen, or a vinyl group; more preferably, the polysiloxane polymer is hydroxyl terminated dimethylsiloxane.

In another embodiment, the tie coat polymer blend further comprises an organic monomer(s) capable of undergoing free radical polymerization in the presence of in-situ generated free radicals; preferably mono-olefinic monomers; more preferably ethylene monomers, propylene monomers, butene monomers, vinyl chloride monomers, vinyl fluoride monomers, fluoroacrylates, vinyl acetate monomers, styrene monomers, ring substituted styrene monomers, vinylpyrrolidine monomers, vinylnaphthalene monomers, N-vinylcabazole monomers, N-vinylpyrrolidone monomers, acrylic acid monomers, methacrylic acid monomers, acrylonitrile monomers, methacrylonitrile monomers, vinylidine fluoride monomers, vinylidine chloride monomers, acrolein monomers, methacrolein monomers, maleic anydride monomers, stilbene monomers, indene monomers, maleic acid monomers, or fumaric acid monomers.

In yet another embodiment, the organic polymer is styrene, butylacrylate, other alkylacrylates or a mixture thereof.

In still another embodiment, the in-situ generated free radicals are initiated by the addition of benzoyl peroxide or di-t-butylperoxide, cumene hydroperoxide, and t-butyl hydroperoxide.

In another aspect of the invention, the tie coat polymer blend is comprised of further capable of being atomized and sprayed for application to a surface. In a further aspect, the tie coat polymer blend, further comprises a silicone fluid capable of increasing the sprayability of the blend.

In still yet another embodiment, the tie coat polymer is further capable of forming an intimate covalent bond matrix with a surface to which it is applied.

In another aspect of the invention, the tie coat polymer blends have a viscosity of from about 40,000 to about 400,000 centipoise at about 25° C.; preferably about 80,000 to about 250,000 centipoise at 25° C.; and more preferably, about 95,000 to about 150,000 centipoise at 25° C.

In another aspect of the invention, the surface coat has a viscosity of about 8,000 to about 18,000 centipoise at 25° C.; preferably about 9,000 to about 15,000 centipoise at 25° C.; more preferably, about 10,000 to about 12,000 centipoise at 25° C.

In still another aspect of the invention, the curing agent of the tie coat polymer blend which further comprises a curing agent, is not a tin-based catalyst, preferably N,N′,N″-Tricyclohexyl-1-methyl silanetriamine, platinum-based, or titanium-based catalysts, or other non-tin-based catalysts or organic-based catalysts, like crosslinker CA-40 (Wacker Chemie).

In another aspect, the invention encompasses an fouling release system comprising an anticorrosive epoxy layer applied to a substrate, a tie coat polymer blend as herein applied to the epoxy layer, and a silicone surface coat applied to said tie coat polymer blend, wherein said epoxy layer comprises a silane coupling agent having primary or secondary amines.

In some embodiments of the fouling release system, the tie coat polymer blend further comprises a silicone fluid.

In another embodiment of the fouling release system, the substrate is cleaned before application of the anticorrosive epoxy layer; preferably the substrate is grit-blasted before application of the anticorrosive epoxy layer.

In still other embodiments of the fouling release system, the silicone surface coat further comprises a release oil.

In another aspect, the invention encompasses an fouling release polymer system comprising a first anticorrosive epoxy layer applied to a substrate, a second anticorrosive epoxy layer applied to said first anticorrosive epoxy layer, a tie coat polymer blend as described herein is applied to said second anticorrosive epoxy layer, and a silicone surface coat applied to said tie coat polymer blend, wherein said second anticorrosive epoxy layer further comprises a silane coupling agent having primary amines.

In some embodiments of the fouling release system, the tie coat polymer blend further comprises a silicone fluid.

In another embodiment of the fouling release system, the substrate is cleaned before application of the anticorrosive epoxy layer; preferably the substrate is grit-blasted before application of the anticorrosive epoxy layer.

In still other embodiments of the fouling release system, the silicone surface coat further comprises a release oil.

In another aspect, the invention encompasses an fouling release polymer system comprising an anticorrosive epoxy layer applied to a substrate, and a release layer applied to said anticorrosive epoxy layer comprising a silicone surface coat blend and a tie coat polymer blend as described herein, wherein said anticorrosive epoxy layer further comprises a silane coupling agent having primary amines.

In some embodiments of the fouling release system, the tie coat polymer blend further comprises a silicone fluid.

In another embodiment of the fouling release system, the substrate is cleaned before application of the anticorrosive epoxy layer; preferably the substrate is grit-blasted before application of the anticorrosive epoxy layer.

In still other embodiments of the fouling release system, the silicone surface coat further comprises a release oil.

In still other embodiments of the fouling release system, a single applied layer accomplishes the functionality of both the tie coat and foul release layer. This single applied layer, the monoplex, incorporates both the tie coat blend material and the top coat material. The amount of top coat blend resin in the monoplex is between 5% and 99%, or preferably between 50% and 99%, and most preferably between 75% and 95%. Conversely, the amount of top coat resin incorporated into the monopolex layer is between 1% and 95%, or preferably between 1% and 50%, and most preferably between 5% and 25%.

In another aspect, the invention encompasses a method for preparing a composition comprising contacting an organopolysiloxane and one organic polymer wherein said organic polymer is comprised of monomers that polymerize to single chain polymers and wherein said organic polymer is not comprised of crosslinking multifunctional monomers

In one embodiment, the method further comprises contacting a free-radical initiator with the organopolysiloxane and/or organic monomer.

In some embodiments, the free-radical initiator is an azo-bis-alkylnitrile; preferably AIBN. In other embodiments, the free-radical initiator is a peroxide; preferably benzoyl peroxide, di-t-butylperoxide, cumene hydrogenperoxide, or t-butyl hydrogen peroxide.

In still another embodiment, the polysiloxane polymer has the repeating unit formula

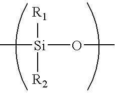

wherein R₁ and R₂ are independently substituted or unsubstituted C1-C3 alkyl, or substituted or unsubstituted aryl, wherein said substituents, if present, are chosen from cyano, halogen or another group which does not provide another linking functionality.

In yet another embodiment, at least one terminal end of the polysiloxane polymer has at a terminal reactive group; preferably the terminal reactive group is a hydroxyl group, an alkoxy group, an aryloxy group, an amino group, an amido group, a halogen, or a vinyl group; more preferably, the polysiloxane polymer is hydroxyl terminated polydimethylsiloxane. In other embodiments, the hydroxyl terminated polydimethylsiloxane has viscosity of less than 100 centistokes at 25° C. In still other embodiments, the hydroxyl terminated polydimethylsiloxane has viscosity between 2000 to 8000 centistokes at 25° C. In yet other embodiments, the hydroxyl terminated polydimethylsiloxane has viscosity between 10,000 to 50,000 centistokes at 25° C.

In another embodiment, the tie coat polymer blend further comprises an organic monomer(s) capable of undergoing free radical polymerization in the presence of in-situ generated free radicals; preferably mono-olefinic monomers; more preferably ethylene monomers, propylene monomers, butene monomers, vinyl chloride monomers, vinyl fluoride monomers, fluoroacrylates, vinyl acetate monomers, styrene monomers, ring substituted styrene monomers, vinylpyrrolidine monomers, vinylnaphthalene monomers, N-vinylcabazole monomers, N-vinylpyrrolidone monomers, acrylic acid monomers, methacrylic acid monomers, acrylonitrile monomers, methacrylonitrile monomers, vinylidine fluoride monomers, vinylidine chloride monomers, acrolein monomers, methacrolein monomers, maleic anydride monomers, stilbene monomers, indene monomers, maleic acid monomers, or fumaric acid monomers.

In yet another embodiment, the organic polymer is comprised of styrene, butylacrylate, other alkylacrylates or a mixture thereof.

In another embodiment, the polymers of the method have typical weight-average molecular weights of from about 80,000 to about 250,000 and more preferably from about 120,000 to about 160,000.

In still another embodiment, the method is performed in a nitrogen sparged atmosphere.

In another embodiment, the method further comprises contacting with a bifunctional tethering agent; preferrably the bifunctional tethering agent comprises a primary and/or secondary amine functionality and a siloxane-like functionality.

In yet another embodiment, the initiator of the method is introduced to the organopolysiloxane and/or organic monomer in a plurality of doses. In another embodiment, the initiator of the method is introduced to the organopolysiloxane and/or organic monomer in a single dose.

In another embodiment, the method further comprises contacting with a curing agent, wherein said curing agent is not a tin-based catalyst.

In still another embodiment, the shear rates contemplated during polymerization to form the tie coat polymer blend is typically in the range of from about 10 min⁻¹ to about 1,500 min⁻¹, and more preferably from about 100 min⁻¹ to about 1,000 min⁻¹. In yet another embodiment, the product produced by the method does not possess elongated microphase separated polymer morphology.

In still another embodiment, the method further comprising addition of water.

In another aspect, the invention encompasses a method for preparing a surface having fouling release properties comprising applying a fouling release tie coat polymer blend as described herein to a surface.

In another aspect, the invention encompasses a method for preparing a surface having fouling release properties comprising applying a fouling release system as described herein to a surface.

In one embodiment of the methods for preparing a surface, the surface is a substrate comprising an anticorrosive epoxy.

In another embodiment of the methods for preparing a surface, the method further comprises applying a surface coat; preferably a silicone surface coat.

In another aspect, the invention encompasses a product made by the process of contacting an organopolysiloxane and one organic polymer wherein said organic polymer is comprised of monomers that polymerize to single chain polymers and wherein said organic polymer is not comprised of crosslinking multifunctional monomers.

In one embodiment, the product is made by a process that further comprises contacting a free-radical initiator with the organopolysiloxane and/or organic monomer.

In another embodiment, the product is made by a process in which the contacting is performed in a nitrogen sparged atmosphere.

In still another embodiment, the product is made by a process which further comprises the addition of water.

### BRIEF DESCRIPTION OF THE DRAWINGS

FIG. 1. shows a schematic of a Duplex fouling release system comprising a first and second anticorrosive epoxy layer, said second epoxy layer bound to a tie coat polymer blend which is then coated with a silicone surface coat.

FIG. 2. shows a schematic of a Duplex fouling release system comprising a single anticorrosive layer, said layer bound to a tie coat polymer blend which is then coated with a silicone surface coat.

FIG. 3. shows the peel test geometry of a substrate coated with a conventional silicone treatment versus a substrate coated with a duplex silicone surface.

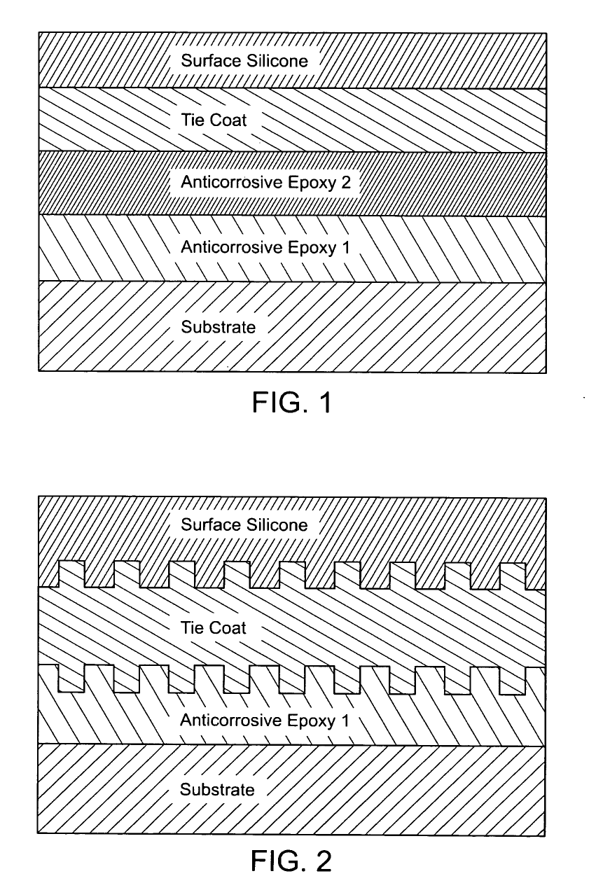

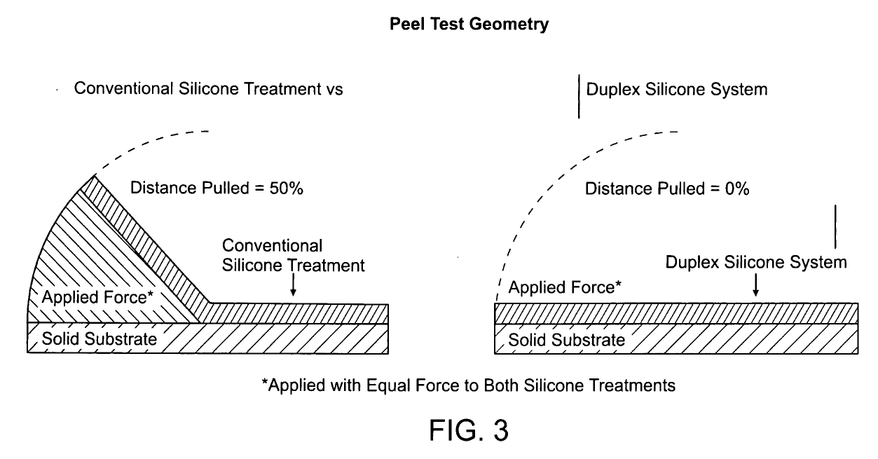

### DETAILED DESCRIPTION

### Definitions

In order that the invention may be more readily understood, certain terms are first defined and collected here for convenience. Other definitions appear in context throughout the application.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

As used herein, the term “anti-fouling”, “antifouling”, “fouling release,” “foulant release,” and “release of fouling organisms,” are used interchangeably and refer to the process of removing the accumulation or preventing the accumulation of undesirable accumulation of microorganisms, plants, algae, and animals on submerged structures, especially ship hulls.

The term “fouling release tie coat polymer blend” or “tie coat polymer blend” refers to a polymer blend capable of binding a substrate or other surface so as to provide a toughness and/or stiffness which in turn hinders the binding of marine fouling materials and/or prevents the accumulation of marine fouling materials when exposed thereto. The term “fouling release system” herein refers to a surface which is coated with various layers to having fouling release properties. Such examples include, but are not limited to: a first and second anticorrosive epoxy layer, said second epoxy layer bound to a tie coat polymer blend, which is coated with a surface coat; an epoxy sealant and an epoxy barrier comprising a tethering agent, a tie coat polymer blend, and a surface coat; or an epoxy barrier comprising a tethering agent, a tie coat polymer blend, and a surface coat.

The term “crosslinking multifunctional monomers” refers to monomers which are capable of forming a crosslinked polymer chain when homopolymerized.

The term “halogen” refers to fluorine, chlorine, bromine or iodine.

As used herein, the term “alkyl” refers to a straight-chained or branched hydrocarbon group containing 1 to 50 carbon atoms. Examples of alkyl groups include, but are not limited to methyl, ethyl, n-propyl, isopropyl, tert-butyl, and n-pentyl. Alkyl groups may be optionally substituted with one or more substituents.

The term “C1-C3 alkyl” refers to a straight or branched hydrocarbon chain radical, containing solely carbon and hydrogen atoms, having in the range from one up to three carbon atoms, and which is attached to the rest of the molecule by a single bond, such as illustratively, methyl, ethyl, n-propyl, and 1-methylethyl(iso-propyl).

The term “aryl” refers to a hydrocarbon monocyclic, bicyclic or tricyclic aromatic ring system. Aryl groups may be optionally substituted with one or more substituents. In one embodiment, 0, 1, 2, 3, 4, 5 or 6 atoms of each ring of an aryl group may be substituted by a substituent. Examples of aryl groups include phenyl, naphthyl, anthracenyl, fluorenyl, indenyl, azulenyl, and the like. Additionally, the term “aryl” refers to a hydrocarbon monocyclic, bicyclic or tricyclic bridged ring systems wherein at least one rings is aromatic.

The term “alkoxy” refers to an —O-alkyl radical. The term “aryloxy” refers to an —O-aryl radical. An “amido” is an —C(O)NH₂.

As used herein the term “substituent” or “substituted” means that a hydrogen radical on a compound or group (such as, for example, alkyl, alkenyl, alkynyl, alkylene, aryl, aralkyl, heteroaryl, heteroaralkyl, cycloalkyl, cyclyl, heterocycloalkyl, or heterocyclyl group) is replaced with any desired group that does not substantially adversely affect the stability of the compound. Examples of substituents include, but are not limited to, halogen (F, Cl, Br, or I), hydroxyl, amino, alkylamino, arylamino, dialkylamino, diarylamino, alkylarylamino, cyano, nitro, mercapto, thio, imino, formyl, carbamido, carbamyl, carboxyl, thioureido, thiocyanato, sulfoamido, sulfonylalkyl, sulfonylaryl, alkyl, alkenyl, alkoxy, mercaptoalkoxy, aryl, heteroaryl, cyclyl, heterocyclyl, wherein alkyl, alkenyl, alkyloxy, alkoxyalkyl, aryl, heteroaryl, cyclyl, and heterocyclyl are optionally substituted with alkyl, aryl, heteroaryl, halogen, hydroxyl, amino, mercapto, cyano, nitro, oxo (═O), thioxo (═S), or imino (═NR).

The term “terminal reactive group” refers to a group bound to the terminal end of a polysiloxane polymer which is further capable of undergoing a chemical reaction with another compound or nearby reactive group. Terminal reactive groups include, but are not limited to, a hydroxyl group, an alkoxy group, an aryloxy group, an amino group, an amido group, a halogen, or a vinyl group.

The term “organic monomer(s) capable of undergoing free radical polymerization in the presence of in-situ generated free radicals” refers to a polymer made of organic monomers which are capable of forming a polymer through reaction with radicals generated by the monomers themselves rather than by reaction with external free radical generators.

The term “mono-olefinic” refers to a monomer having only one reactive carbon-carbon double bond. Regarding the invention, one reactive carbon-carbon double bond is actually difunctional since it can bond to two neighboring monomers. Mono-olefinic monomers include, but are not limited to, ethylene monomers, propylene monomers, butylene monomers, vinyl chloride monomers, vinyl fluoride monomers, fluoroacrylates, vinyl acetate monomers, styrene monomers, ring substituted styrene monomers, vinylpyridine monomers, vinylnaphthalene monomers, N-vinylcabazole monomers, N-vinylpyrrolidone monomers, acrylic acid monomers, methacrylic acid monomers, acrylonitrile monomers, methacrylonitrile monomers, vinylidine fluoride monomers, vinylidine chloride monomers, acrolein monomers, methacrolein monomers, maleic anydride monomers, stilbene monomers, indene monomers, maleic acid monomers, or fumaric acid monomers.

The term “bifunctional tethering agent” refers to a compound or compounds used to form a molecular bridge through covalent bonding, between a tie coat and an epoxy layer. In certain embodiments, the bifunctional tethering agent comprises a combination of primary and/or secondary amine functionality and a siloxane-like functionality. The term “siloxane-like functionality” refers to, typically, triethoxysilane and trimethoxysilane.

The term “elongated morphology” refers to having morphological features in the phase separated or microphase separated material that are rod-like or needle-like.

The term “silicone fluid” refers to a silicone based liquid or flowable material which, when added to a polymer, reduces the viscosity and increases the ability of said polymer to be sprayed onto a surface by a forced spray nozzle, and also improves the fouling release properties. Silicone fluids include, but are not limited to SF69 and SF1147.

The term “curing agent” refers to an organic or inorganic catalyst or other material which is capable of curing the tie coat resin by reaction with terminal Si—OH groups. Curing agents include but are not limited to N,N′,N″ Tricyclohexyl-1-methyl silanetriamine, tin based catalysts, platinum based catalyst, or other non-tin based catalysts.

The term “anticorrosive epoxy layer” refers to a thermosetting polymer, that cures by the reaction of epoxide and amine functionalities, that provides corrosion protection for metal, concrete barriers, or water incursion barriers, and may be further used as a primer to improve the adhesion of marine paints especially on metal surfaces where corrosion (rusting) resistance is important.

The term “substrate” and “surface” are herein used interchangeably and refer to various surfaces, including but not limited to ships, boats, submarines, power plants, cement pipes, sewage and underground pipes, law sprinkler systems, and de-icing of power lines and windmills. Such surfaces include marine and industrial environments, including marine vessels and power plant coolant water intake applications. Additional applications include applicants where water from the environment is used in an industrial process. More specifically, surfaces include boat hulls, out-drives, rudders, and trim tabs. Such surfaces include, but are not limited to, fiberglass, blistered fiberglass, wood, wooden hulls, existing paint, steel, steel hulls, aluminum, and metal parts including underwater metal parts. Other substrates include buildings, roofs, water purification systems, and desalinization systems.

The term “release oil” refers to a material which, when incorporated into a polymer resin or silicone surface material slowly diffuses over time, or stays at the surface, thereby increasing fouling release properties for the material. Release oils include, but are not limited to low molecular weight silicone based oils, SF1147, SF1154, DMSC 15, and DBE 224.

It is also to be understood that the terminology used herein is for purposes of describing particular embodiments only, and is not intended to be limiting. As used in the specification and the appended claims, the singular forms “a”, “an”, and “the” include plural referents unless the context clearly indicates otherwise. Thus, for example, reference to “a peptide” includes multiple peptides, reference to “a spacer” includes two or more spacers.

Unless otherwise defined, all technical and scientific terms used herein have the same meaning as commonly understood by one of ordinary skill in the art to which this invention belongs. In case of conflict, the present application, including definitions will control. All publications, patent applications, patents, and other references mentioned herein are incorporated by reference.

### Tie Coat Compositions

The tie coat compositions of the invention contain monomers that polymerize to single chain polymers and do not contain crosslinking multifunctional monomers. Such tie coats are stable graft polymers and copolymers which are comprised of a polymer blend (stabilized by graft copolymers) rather than a simple graft polymer.

The tie coats of the invention do not possess elongated morphologies that have been previously disclosed (see, e.g., U.S. Pat. No. 5,449,553 and U.S. Pat. No. 5,593,732). The tie coats of the invention do not require high shear for high toughness morphologies and only require sufficient shear to achieve a homogenous mixture of starting materials for polymerization. What is observed in the tie coat formulations are small spheroid particle morphologies (observed by electron micrographs) that achieve equivalent or better levels of toughness to absorb mechanical insult during ship operation and other abrasive environments, and imparts this toughness to surface coat by chemical bonding between surface and tie coat (silicon, butyl acrylate and polystyrene-block co-polymer). The tie coat forms an intimate covalent matrix to impart a toughness to the silicon surface coat without diminishing the fouling releasing properties of the silicon top coat. It is understood that while the flexing or other fouling release mechanisms of the top silicon coat are not compromised, the adhesion properties of the peptide or other glue released by the animals is compromised such that the bond between the animal and the surface is attenuated, where the bond may or may not ever cure or fully set.

Advantages enjoyed by the tie coats or systems employing tie coats of the invention include performance reliability (superior release capability and fuel savings when applied to marine vessels); non-toxicity as a result of lacking heavy metals and biocides; environmental safety (waste is non-hazardous allowing for disposal in sanitary landfills after removal from hull or other apparatus); superior release properties including removal of fouling by water jet or self cleaning; quick application (application using a conventional airless spray equipment using a silicone spray line); and operational durability and layer adherence.

### Anticorrosive Epoxy Coat Containing a Tethering Agent to Form Silicone-to-Silicone Bonding

In other aspects of the present invention, the anticorrosive epoxy layer further comprises a silane coupling agent having amines, such as primary and/or secondary amines. For example, a compound known as SCM 501C is added to an epoxy layer (if more than one epoxy layer is used, then the SCM 501C is added to the outermost or last applied layer). See U.S. Pat. No. 6,391,464, entitled Epoxy Coatings and Surfaces Coated Therewith. We have subsequently discovered that several other reagents will improve this bond via silicone-to-silicone bonding while using substantially less material reagent. These new reagents include but are not limited to: methylaminopropyltrimethoxysilane, N-phenylaminopropyltrimethoxysilane, and cyclohexylaminopropyltrimethoxysilane.

### Application to Surfaces

In certain embodiments, the tie coat has a silicone fluid incorporated into the final product that allows a much easier spray application. This fluid can be incorporated at a volume of approximately 1% to about 30%, and in certain embodiments 15%.

In one embodiment, the tie coat is bonded to a surface coat. The tie coat of the invention bonds to a surface coat through silicone cross linking between the tie coat and surface coat. This bond is covalent in nature and very strong. The nature of this bond creates a “oneness” between the two layers. This “oneness” results in a transmission of toughness to the surface coat from the tie coat and allows the entire system to achieve a toughness that is not present in traditional silicone coatings. The surface coat has this toughness which provides a much more resilient surface compared to standard silicone fouling release materials while maintaining the fouling release characteristics required. This results in a coating that is superior in damage resistance, debonding resistance, and longevity.

In another embodiment the invention provides a tie coat bonded to epoxy. The tie coat bonds to the epoxy in both physical/mechanical as well as chemical means. Additionally, a bifunctional tethering agent is added that contains an amine functionality at one end of the molecule with a siloxane-like functionality at the other end. Since silicones form low energy surfaces, some of the siloxane functionality rises to the surface (herein referred to as “self-assembling”) of the epoxy preparing to bond with the tie coat silicone functionalities. The amine functionality bonds to the epoxide functionality in the epoxy layer while the silicone molecules that self-assemble at the air-surface side of the epoxy layer bind to silicone molecules in the Tie Coat. Examples of bifunctional tethering agents contemplated by the present invention include SCM 501C, aminopropyltriethoxysilane, aminopropyltrimethoxysilane, methylaminopropyltrimethoxysilane and cyclohexylaminopropyltrimethoxysilane. See Table 1 below.

Further contemplated by the invention is a tie coat bonded to epoxy which is bonded to a substrate and a top coat bonded to a tie coat bonded to epoxy bonded to a substrate.

### Polysiloxanes

The polysiloxanes used in this process are polymers that conform to the general repeating unit formula

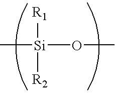

where R₁ and R₂ are organic groups, especially alkyl groups of 1-3 carbon atoms which may be substituted and which may be the same or different and in the simplest case they are methyl groups (poly(dimethylsiloxane), PDMS). The R₁ and R₂ groups may also be other monovalent alkyl or aryl radicals or they may be substituted, for example with halogen substitutents or with cyano groups. The ends of the polysiloxane chains bear terminal reactive groups, such as hydroxyl, alkoxy, aryloxy, amino, amido, halo, and vinyl. These terminal groups are used in setting or curing of the polysiloxane blends and/or in bonding the layer containing these structures to a polysiloxane topcoat such as RTV11 or a tethering agent.

An example of suitable end-functionalized polysiloxanes that are useful in forming the stable polymer blends of this invention are hydroxyl-terminated silicone fluids. The viscosities of useful fluids may range from about 500 to 50,000 cps and more preferably from 1,000 to 20,000 cps at 25° C.

The free radically polymerizable monomers may be any polymerizable mono-olefinic monomer such as ethylene, propylene, butene, vinyl chloride, vinyl fluoride, vinyl acetate, styrene, ring substituted styrenes, vinylpyridine, vinylnaphthalene, N-vinylcarbazole, N-vinylpyrrolidone, acrylic acid and methacrylic acid, their derivatives including salts, esters, and amides, acrylonitrile, methacrylonitrile, vinylidine fluoride, vinylidene chloride, acrolein, methacrolein, maleic anhydride, stilbene, indene, maleic and fumaric acids and their derivatives, and conjugated dienes such as butadiene and isoprene. In certain embodiments, the monomers may include fluorinated analogs of the monomers provided supra. These monomers may be polymerized singly, or in combinations of two or more, in the presence of the polysiloxane and a free radical source. While polyfunctional “crosslinking monomers” such as divinylbenzene, ethylene glycol dimethacrylate, trimethylolpropane trimethacrylate, pentaerythritol tetramethacrylate, etc., may be used in the present invention in very small amounts (<about 5% and most preferable <1% based on the weight of the mono-olefinic monomer(s)), the use of only monomers containing a single polymerizable olefinic group is preferred in order to avoid gelation while allowing the free radical initiator to be added to the reactants in a single batch in a one-pot process.

The proportion of organopolysiloxane used may be varied within wide limits but is preferably 25 to 60% by weight of the reactants.

The free radical initiation process may involve common free radical initiators such as peroxides or azobisisobutyronitrile (AIBN), redox initiators, photoinitiators, or the creation of radicals through thermal treatment or use of ionizing radiation. The preferred initiators are peroxides and hydroperoxides of the formula ROOR, ROOH, and RCOOOR, (wherein each R is independently alkyl or aryl) such as benzoyl peroxide, t-butyl hydroperoxide, dicumyl peroxide, t-butyl perbenzoate, and the like, as well as AIBN.

The amount of free radical initiator used will typically be in the range of 0.005% to 2% based on the combined weight of organopolysiloxane and monomer. Generally a single initiator will be used, although two or more initiators may be employed. Generally the initiator is added in a single batch at the start of the polymerization process, although it is possible to add the initiator in increments.

The temperature for the free radical polymerization is not critical but should be varied to generate a suitable temperature for decomposition of the initiator chosen. Generally this temperature is in the range of 50-150° C.

The free radical polymerization is preferentially carried out with stirring under an inert atmosphere in the presence of a liquid that boils in the range of 50-150° C. This liquid should have a low chain transfer constant, limiting its participation in the chemical reactions that are occurring. Preferentially, water may be used for this purpose even though it does not dissolve polysiloxanes or most vinyl monomers.

Generally it has been considered that crosslinking is required to generate stable polymer blends of the “interpenetrating polymer network” type. By stable, we mean polymer blends that will not de-mix on storage. This explains the use of a “polyfunctional (crosslinking) monomer” by Griffith (U.S. Pat. No. 5,449,553, the contents of which are incorporated by reference) in the preparation of similar organopolysiloxane-based release layers. In our case, we are able to generate non-crosslinked polymer blends that are stabilized by in-situ generated graft copolymers that serve as macromolecular surfactants for stabilizing the mixture of the pre-formed polysiloxane and the free radically produced polymer. During the reaction the free radicals that are generated may create graft copolymers composed of a polysiloxane backbone and side chains of the free radically polymerized monomer(s) by chain transfer to polysiloxane. However, the product of the free radical process is clearly a polymer blend rather than phase separated graft copolymer as evidenced by the micrometer length scale of phase separation. Graft copolymers microphase separate on the scale of a few to a hundred nanometers, while polymer blends, even when stabilized by copolymer surfactants, exhibit phase separation on the micron scale or larger. The opaque (white) appearance of the products of the process reported herein provides strong evidence of creation of polymer blend on a micrometer length scale which is thus able to scatter light rather than a graft copolymer as the dominant product.

A surprising aspect of the present invention is the long term stability of the novel polymer blends in the absence of crosslinking. Blends of incompatible polymers phase separate on storage and addition of block copolymers is usually rather inefficient in stabilizing them since most of the added block copolymer forms micelles. However, in the present case, the generated polymer blends are completely soluble in suitable solvents, indicating that no crosslinking is present, and they have been stored for periods of >2 years without any indication of macroscopic phase separation.

In one embodiment, the tie coat imparts mechanical strength and toughness to a top coat due to its chemical structure, physical properties and morphology. One example of a tie coat includes a hydroxy-terminated poly(dimethylsiloxane) that is partially grafted with a random copolymer of n-butylacryate and styrene. Such a structure is shown below:

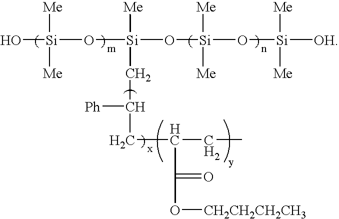

Exemplified components of the tie coat are graft copolymers with polydimethylsiloxane (PDMS) backbones and grafted chains of a poly(styrene-co-n-butyl acrylate). The chemical species provides covalent bonds between silicone functionalities and styrene/acrylic polymer groups, and the graft copolymer acts to stabilize and prevent different components in the tie coat from undergoing macroscopic phase separation. The free hydroxyl groups allow bonding to both the silicone rubber top coat and to the epoxy substrate, as well as the tethering agent. Additionally, the free hydroxyl groups are allowed to react with a silane coupling agent that is added into the epoxy protective coating, providing strong adhesion between the epoxy base coat and the tie coat. Further, the hydroxyl groups are capable of reacting and linking into a crosslinked network of the top coat. Such bonding allows for efficiency of stress transfer between the two layers and strengthens the material.

The glass transition temperature T_{g} of the silicone rubber surface coat ranges from about −150° C. to about −60° C., preferably around −120° C., resulting in a soft surface coat. However, the tie coats of the invention contain styrene based polymers, such as poly(styrene-co-n-butylacrylate) copolymer, having about 75 wt % n-butylacrylate, which has a much higher Tg, ranging from about −50° C. to about 0° C., preferably around −20° C. The higher glass transition temperature provides a toughening of the material, which allows the material to absorb the mechanical energy of impacts and scrapes. The silicone functionality which is bonded to the tie coat maximizes the transfer of mechanical energy from the weaker top coat into the tie coat where it is absorbed and dissipated.

### Monolayer Fouling Release Systems

Another aspect of the invention is a monoplex system that enhances the bonding of the fouling release compositions here to underlying substrates (e.g., ship hulls, tunnel, hose or pipe surfaces, windmill surfaces, power lines and the like). The Monoplex System provides enhanced bonding of fouling release coatings to the underlying substrate (ship hull or utility intake tunnel, etc.).

The monoplex system comprises a unique formulation of tie coat and surface coat chemistries that “self assembles.” This monoplex systems, when assembled and cured, provides a smooth polysiloxane RTV-like surface coat with extremely effective fouling release properties along with the durability contributed by the tie coat chemistries assembling below the surface fouling release chemistry.

The mixed layer of the Monoplex system assembles itself to have the tie coat and top surface functionality that it needs within the single applied layer. Once applied to the surface the top coat components rise toward the surface and the tie coat components move down toward the underlying epoxy. The Monoplex system does not have well defined layers even after this self assembly process has occurred during cure. The bottom is richer in the tie coat material and top is richer in the surface coat material and there is a gradual change in composition from layer bottom to layer top (self-assembly). This self-assembling release coating allows greater ease of application and maintenance.

In one aspect the Monoplex system comprises an anticorrosive epoxy layer applied to a substrate, and a monoplex layer applied to said anticorrosive epoxy layer comprising a blend of silicone surface coat material and a tie coat material. In other aspects, the anticorrosive epoxy layer further comprises a silane coupling agent having amines, such as primary and secondary amines. For example, a material known as SCM 501C is added to the epoxy layer (if more than one epoxy layer is used, then the 501C is added to the outermost or last applied layer). See U.S. Pat. No. 6,391,464, entitled Epoxy Coatings and Surfaces Coated Therewith We have subsequently discovered that several other reagents will improve this bond while using substantially less material reagent. These new reagents include but are not limited to: methylaminopropyltrimethoxysilane, N-phenylaminopropyltrimethoxysilane, and cyclohexylaminopropyltrimethoxysilane.

In the monoplex single layer embodiment the amount of tie coat resin, incorporated in the blend with surface coat resin, is between 5% and 99%, or preferably between 50% and 99%, and most preferably between 75% and 95%. Conversely, the amount of surface coat resin incorporated into the blended single layer is between 1% and 95%, or preferably between 1% and 50%, and most preferably between 5% and 25%. In certain embodiments, the amount of tie coat resin is around 85%, and the amount of surface coat is around 15%.

Release oils may be incorporated into the monoplex system in a similar fashion to their incorporation in the surface coat of the duplex system. Release oils include SF1147, SF1154, DMSC15 and DBE224. They may be present in the monoplex in amounts ranging from 0.1% to 40% based on the amount of mixed tie and surface coat materials. In certain embodiments, a silicone fluid is added to aid the sprayability of the monoplex coating. In a further embodiment, the silicone fluid is selected from SF69 and SF1147.

In other aspects, the tie coat polymer blend is modified to incorporate a perfluorinated acrylate or methacrylate (or some other fluorinated monomer). The incorporation of fluoropolymer into the tie coat improves its fouling release properties and may allow it to be used as the surface coat.

Further, the tie coat bonds very strongly when applied to glass-filled fiberglass. No coupling agent or surface treatment is required. This could be extended to other surfaces, e.g. polyurethanes or acrylics, etc.). As such, the mixed layer of the Monoplex System can, in some aspects, be applied directly to a substrate without the presence of an anticorrosive epoxy layer.

### Duplex Fouling Release Systems

Another aspect of the invention is a duplex system that enhances the bonding of the fouling release compositions to underlying substrates (e.g., ship hulls, tunnel, hose or pipe surfaces, windmill surfaces, power lines and the like). The Duplex System provides enhanced bonding of fouling release coatings to the underlying substrate (ship hull or utility intake tunnel, etc.).

A compound known as SCM 501C is added to the second epoxy layer (if only one epoxy layer is used, then the 501C is added here). See U.S. Pat. No. 6,391,464, entitled Epoxy Coatings and Surfaces Coated Therewith. We have subsequently discovered that several other reagents will improve this bond while using substantially less material reagent. These new reagents include but are not limited to methylaminopropyltrimethoxysilane, N-phenylaminopropyltrimethoxysilane, and cyclohexylaminopropyltrimethoxysilane.

Due to their bi-functional nature, these reagents act by a unique mechanism whereby: 1. Due to the silane function, the reagents will bloom to the surface of the epoxy thereby exposing the silane functionality for covalent bonding to the tie coat. In certain embodiments, the blooming occurs in the epoxy later, wherein the need for polyfunctional reagents has been eliminated. Epoxies are crosslinked. 2. The amine function binds covalently to the epoxide functionality of the epoxy layer. 3. These reagents can be present at as low a concentration as 1% or less and achieve a tight bond. We have tested them at concentrations as high as 30% with good results however, the lower concentration of 1% provides a significant cost advantage.

Further, the tie coat bonds very strongly when applied to glass-filled fiberglass or vinyl ester. No coupling agent, epoxy layer, or surface treatment is required. This could be extended to other surfaces, e.g. polyurethanes or acrylics, etc.). As such, Duplex System can, in some aspects, be applied directly to a substrate without the presence of an anticorrosive epoxy layer. In the aforementioned case of binding tie coat directly to fiberglass or vinyl ester, the adhesion of the tie coat is at least as good as its adhesion to the second epoxy later with the tethering agent in it, in the standard duplex system.

The duplex system is particularly well suited for application to small pipes such as pipes used in irrigation, fire suppression, water transport in buildings, and other similar uses; roofing; wind Turbines/windmills; aircraft; wiring (high tension electrical wires, telephone wires, electrical conduit wires); buildings and foundations (salt erosion inhibitor); power Plant Efficiency; dock surfaces; oil Rigs (Fouling induced requirement to “overbuild” the strength of the pilings); “anti-ice” applications including, roofs, windmills, aircraft wings, ship and oil rig railings and non-step surfaces (wherever device or de-snow is used).

Furthermore, the duplex fouling release system has strong electrical insulating properties and good heat tolerance properties. So uses for the system may also be suited for insulation and in fire retardant applications

### Articles and Coatings

Surface coat silicone viscosity contributes to the improved spray characteristics when the viscosity is reduced 10,000 to 12,000 centipoise. At this range, the compositions herein posses desirable spray characteristics that balance sprayability with achieving coating thickness. Viscosities in the region of 18,000 centipoise are more difficult to spray and require the addition of large amounts of solvent to achieve sprayability. When large quantities of solvent are used, it is difficult to achieve the required coating thickness (build) and the additional solvent creates a regulatory compliance problem due to the level of volatile organic solvent (VOC). The compositions herein provide enhanced ability to apply the surface coat to large installations (large ships and power utility tunnels) and to achieve the required thickness. This makes the Duplex System and Monoplex System very user friendly and results in a much more consistent application process.

### Repair Kits

In certain embodiments, the tie coat and fouling release systems can be provided as a repair kit for use in the patching or repair of a previously installed fouling release system. Such kits may comprise:

One or more marine epoxy corrosion barrier, including but not limited to, Ameron 235 (PPG, Inc.), Ameron 400 (PPG, Inc.), SeaGuard 5000 (Sherwin Williams), SeaGuard 6000 (Sherwin Williams);

One or more marine epoxies containing one or more tethering agents, including but not limited to, SCM501C, or aminopropyltriethoxysilane, aminopropyltrimethoxysilane, methylaminopropyltrimethoxysilane, cyclohexylaminopropyltrimethoxysilane, or N-phenylaminopropyltrimethoxysilane;

A tie coat comprising a silicone oil such as SF 69 (Momentive Performance Materials, Inc.) for sprayability and fouling release, and adhesion enhancer GF-91 (Momentive Performance Materials, Inc.), and a curing agent such as CA-40 (Wacker Chemie, AG); and

A surface coat comprising a silicone release oil such as SF 1147 (Momentive Performance Materials, Inc.) for fouling release properties and sprayability, and a curing agent such as DBT, dibutyltin dilaurate (Momentive Performance Materials, Inc.) or equivalents thereof.

Suitable combinations of tethering agent used in the second epoxy layer include, but are not limited to, those listed in Table 1 below.

TABLE1
Examples of Tethering Agents Used in Second Epoxy Layer

| Number | Description |
|---|---|
| 1 | Epoxy + 30% SCM 501C |
| 2 | Epoxy + 15% SCM 501C |
| 3 | Epoxy + 5% SCM 501C |
| 4 | Epoxy + 6% aminopropyltriethoxysilane |
| 5 | Epoxy + 3% aminopropyltriethoxysilane |
| 6 | Epoxy + 1% aminopropyltriethoxysilane |
| 7 | Epoxy + 6% aminopropyltrimethoxysilane |
| 8 | Epoxy + 3% aminopropyltrimethoxysilane |
| 9 | Epoxy + 1% aminopropyltrimethoxysilane |
| 10 | Epoxy + 6% methylaminopropyltrimethoxysilane |
| 11 | Epoxy + 3% methylaminopropyltrimethoxysilane |
| 12 | Epoxy + 1% methylaminopropyltrimethoxysilane |
| 13 | Epoxy + 6% cyclohexylaminopropyltrimethoxysilane |
| 14 | Epoxy + 3% cyclohexylaminopropyltrimethoxysilane |
| 15 | Epoxy + 1% cyclohexylaminopropyltrimethoxysilane |
| 16 | Epoxy + 6% N-phenylaminopropyltrimethoxysilane |
| 17 | Epoxy + 3% N-phenylaminopropyltrimethoxysilane |
| 18 | Epoxy + 1% N-phenylaminopropyltrimethoxysilane |

Repair kits of the invention may be used in any reasonable manner. For materials such as Steel, Aluminum, other metals, Fiberglass, Wood, and other non or less porous materials, the following method may be utilized.

First, the surface is prepared by cleaning, preferrably with no loose material exposed. For debonded areas, debonded material may be removed by scoring the coating with an appropriate tool such as a knife, and removing debonded material back to intact coating.

If coating debond extends to the substrate surface, a first coat of marine epoxy may be applied to the clean, dry exposed substrate surface. If the area to be coated is small, less than approximately 100 to 200 square feet, a hand application with a brush or roller is appropriate. All of the coating layers may be applied by hand or by using airless or other appropriate spraying equipment and applied according to the preference of the applicator. For many applications of a repair kit, this first coat of epoxy will be applied by hand or by spray to a thickness of 6 to 9 mM (wet film thickness).

Once a first coat of marine epoxy is at the stage of “dry tack”, assessed, for example, by pressing the back of a finger onto the epoxy and removing the finger with no epoxy paint adhering to the finger, yet the surface is tacky, then the second coat of epoxy containing the tethering agent may be applied. In some applications of a repair kit, application of the second coat of epoxy may proceed well after the tackiness has dissipated and for up to several days, preferrably within 24 hours. This second coat of epoxy, containing tethering agent, may be applied by hand or by using airless or other appropriate spraying equipment and applied according to the preference of the applicator. For many applications of a repair kit, this second coat of epoxy will be applied by hand or by spray to thickness of 6 to 9 mM (wet film thickness).

Once the second coat of epoxy, containing tethering agent, has been applied, the Tie Coat may be applied once the second coat of Epoxy has reached a state of “dry tack” as described above. Alternatively, one may wait for 24 or more hours prior to the application of the Tie Coat, since the tethering moiety migrates and remains at the surface of the second epoxy awaiting bonding to the tie coat. The tie coat is applied to a thickness of 10 to 16 mM (wet film thickness). The tie coat may be applied by hand using brush or roller or by high pressure airless spray equipment, such as the Graco Premier sprayer (45 to 1 or greater pressure enhancement).

Once the Tie Coat has reached a dry tack, approximately 1 to 2 hours, a surface coat may be applied. Alternatively, one may wait for 24 or more hours prior to the application of the Surface Coat since the bonding between the two coating layers is through silicone-silicone interactions present in both the Tie Coat and the Surface Coat. The Surface Coat is applied to a thickness of 16 to 20 mM (wet film thickness). The Surface Coat may be applied by hand using brush or roller or by high pressure airless spray equipment, such as the Graco Premier sprayer (56 to 1 pressure enhancement)

Finally, once the Surface Coat is dry (one to several hours pending temperature and humidity) the surface will be ready for water immersion. In some applications of a repair kit, the full system will be allowed to cure for one to three days to prevent damage to the coating while in the earlier stages of curing.

For materials such as concrete and other highly porous materials, the first coat of marine barrier epoxy may be replaced by a coat of concrete sealer such as, Ameron NuKlad 105A or its equivalent. This concrete sealer may be applied by hand using a brush or a roller or alternatively may be applied using standard or airless spray equipment.

### Methods of Synthesis

Tie coats previously disclosed are manufactured having an elongated morphology which is produced using high shear rates in a reaction vessel. It is found that elongated morphologies of tie coats are not required to achieve a tie coat which provides comparable or equivalent levels of strength and durability. The resulting method of manufacture is simpler than that previously disclosed and results in a reduction in cost and manufacturing burdens. The resulting morphology is not elongated and provides for greater stability.

In one embodiment of manufacture, water is used to remove heat during tie coat synthesis. The process for the production of the tie coat results in an exotherm as heat is developed in the reaction. There are several ways to control the evolving heat including the presence of a solvent or the presence of a non-miscible fluid. Two properties of water are ideal for this process. The first is water's boiling point of 100° C. We wished to maintain the temperature of the reactor at near 100° C. for the purpose of achieving full reaction without overheating the developing polymer. Additionally, we wished to use a coolant fluid that would be environmentally benign as well as inexpensive. We found that water worked extremely well in controlling the reaction and the reactor. Following the completion of the reaction, the majority of the water is decanted and then the material is heated to 100° C. to drive off the remaining water.

In another embodiment, a radial initiator, such as benzoyl peroxide, was utilized for grafting reactions. There are two methods for the addition of an initiator to a reaction mixture: (i) gradual addition of initiator—Typically this method is used to achieve close control of the reaction, but this requires careful monitoring and equipment to meter in the exact amount of initiator over time during the progress of the reaction; and (ii) initiator added all at once—this method of initiator addition can result in a less well controlled reaction with less well controlled polymer chain length and consistence. However this is an easier method for large scale manufacturing.

In other embodiments, it was determined that elongated morphologies and shear rates did not adversely affect the tie coats of the invention.

### Bonding of Tie Coats to Surfaces

The tie coats and systems of the instant invention can be used on various surfaces and structures subject to environmental and ecological wear and attack (namely fouling, biofilms, algae, bacteria), including but not limited to ships, boats, submarines, docks, piers, pilings, fish nets, power and desalination plants including equipment and other structures associated therewith, cement pipes, sewage and underground pipes, law sprinkler systems, roofs, buildings, turbines, and de-icing of power lines, windmills and air planes. Such surfaces include marine and industrial environments, including marine vessels and power plant coolant water intake applications. Additional applications include those where water from the environment is used in industrial, commercial or recreational processes or is in contact with equipment or structures.

More specifically, such tie coats of the invention may be used on boat hulls, out-drives, rudders, and trim tabs. Such surfaces include, but are not limited to, fiberglass, blistered fiberglass, wood, wooden hulls, existing paint, steel, steel hulls, aluminum, and metal parts including underwater metal parts. The tie coats of the invention are bonded to a surface wherein the covalent bonding between silicone polymer backbones and hydrocarbon polymer grafts in the tie coat is key to the reactive compatibilization of the polymer blend. In one embodiment, a silane coupling agent is used to bond the epoxy layer to the tie coat. An example of a silane coupling agent is SCM 501C (Momentive Performance Materials), which has primary amine groups that bond to epoxide groups in the epoxy coat and which has silicone functionalities that bond to silicone end groups (hydroxyls) in the tie coat. Additionally, the Si—OH groups in the tie coat bond to silicone end groups in the surface coat to affect bonding between the layers.

In another embodiment, a release oil is physically mixed into the surface coat, and slowly diffuses out over time. Release oils include SF1147, SF1154, DMSC15 and DBE224. In one embodiment, the surface coat surface tension is very low; about 20-25 dyne/cm. In another embodiment, the coat thickness ranges from about 8 to about 16 mil, preferably from about 10 to about 14 mil.

In certain embodiments, a silicone fluid is added to aid the sprayability of the tie coat. In a further embodiment, the silicone fluid is selected from SF69 and SF1147.

In another embodiment the viscosity of the resin determines the extent of how well the paint will spray. We have discovered that the viscosity of the surface coat silicone significantly improved spray characteristics when the viscosity was reduced to 10,000 to 12,000 centipoise. Viscosities in the region of 18,000 centipoise were more difficult to spray and required the addition of large amounts of solvent to achieve sprayability. When large quantities of solvent were used, it was difficult to achieve the required coating thickness (build) and the additional solvent creates a regulatory compliance problem due to the level of volatile organic solvent (VOC). This discovery provided the enhanced ability to apply the surface coat to large installations (large ships and power utility tunnels) and to achieve the required thickness.

### Self-Assembly—Silicone-to-Silicone Bonding

While the inventors do not wish to be limited to any particular theory of chemical reaction or mechanism, it is believed that the coatings of the present invention provide for self-assembly of the silicone moieties when free of cross linkers in the tie coat. The epoxy layer that serves as the substrate for the tie coat contains a coupling agent such as SCM 501C, which contains both amine and siloxane functionality, as discussed above. When SCM 501C is mixed with the epoxy and coated on a substrate, there is a tendency, due to the low energy of silicone surfaces, for some of the silicone moieties in the mixture to migrate to the surface, while the amine groups bond to epoxy functionality in the mixture. These silicone groups at the surface of this epoxy layer can then form chemical bonds with some of the —Si—OH groups present in the tie coat formulation. This provides for strong interfacial bonding between the epoxy layer and the tie coat layer. While some of the silicone functionality in the tie coat layer reacts with the tethering agent on the surface of the epoxy layer, we have evidence (XPS experiments reveal that the tie coat surface is rich in silicones) that there is also a tendency for self-assembly (migration of silicone to the surface) during curing of the tie coat layer. This is again driven by the low surface energy of silicone surfaces and is facilitated by the lack of crosslinking in the tie coat polymer blend. Generally speaking, it is believed that the silicone moieties in the Tie Coats and the Epoxy Coats formulated with Tethering Agents in accordance with the present invention have a tendency to self-assemble to the air-surface side of the coats to (a) decrease surface energy and interfacial tension between the layers as they are applied and (b) form chemical bonds between silicone functionality of the tethering agents and of the tie coat. As a result of this self-assembling feature, it is believed that the Epoxy Coat binding to the Tie Coat is no-longer limited to simply overt assembly in which hydrocarbon bonding and Van der Waals intermolecular attractions occur, but also uniquely includes silicone-to-silicone bonding between the Epoxy Coats containing Tethering Agents and the Tie Coats and between the Tie Coats and the Surface Coats due to this self-assembling feature in accordance with the present invention.

It should be appreciated that the coatings or composites of the present invention, especially the Epoxy Coats containing Tethering Agents, Tie Coats and Surface Coats, are low surface energy coatings and include a silicone polymer matrix having natural free volume therein in which silicone oil is present and will very slowly diffuse out therefrom due to the slight gradient at the air-surface side of the Surface Coat.

In addition, it is contemplated by the present invention that the coatings or composites of the present invention, e.g., the free volume in the Surface Coats, can be infused with effective amounts of antifouling, antialgae, antibacterial (bacterialcidal and bacteriostatic), antibiofilm-forming, biocidal, biostatic and other like agents (antifoulants), such as those disclosed in U.S. Pat. No. 7,087,106 entitled Materials and Methods for Inhibiting Fouling of Surfaces Exposed to Aquatic Environments, U.S. Pat. No. 5,314,932 entitled Antifouling Coating and Method for Using Same, U.S. Pat. No. 5,259,701 entitled Antifouling Coating Composition Comprising Furan Compounds, Method for Protecting Aquatic Structures, and Articles Protected against Fouling Organisms, U.S. Pat. No. 5,252,630 entitled Antifouling Coating and Method for Using Same, U.S. Pat. No. 5,248,221 entitled Antifouling Coating Composition Comprising Lactone Compounds, Method for Protecting Aquatic Structures, and Articles Protected Against Fouling Organisms, U.S. Pat. No. 4,788,302 entitled Anti-fouling Compound and Method of Use, U.S. Patent Publication Application No. 20060110456 entitled Method for Biocidal and/or Biostatic Treatment and Compositions therefore, U.S. Patent Publication Application No. 20050159454 entitled Materials and Methods for Inhibiting Fouling of Surfaces Exposed to Aquatic Environments, U.S. Patent Publication Application No. 20040235901 entitled Materials and Methods for Inhibiting Fouling of Surfaces Exposed to Aquatic Environments, Poseidon Ocean Sciences Inc's Natural Bioproducts (NB), including Poseidon's NB17 and NB16 compounds as reported in Life on the Ocean, Life on the Ocean Wave, Dr. Jonathan R. Matias, CEO, Poseidon Ocean Sciences Inc., http://www.poseidonsciences.com/oceanwave_pcj.html, Rittschof, D. 1999, Fouling and natural product antifoulants. In: Recent Advances in Marine Biotechnology, Vol. II. M. Fingerman, R. Nagabhushanam, and M.-F. Thompson (eds), pp. xx. New Delhi: Oxford and IBH Publishing, and Rittschof, D. 1999, Natural product antifoulants: One perspective on the challenges related to coatings development. Biofouling (Special Issue).

### Application Times

The compositions of the invention possess superior ease of application properties. The compositions can be applied by spray methods as they spray as easily as traditional epoxy paints. Thus, the compositions of the invention more easily atomizes during the spraying process resulting in a more uniform spray application and an improved ability to achieve the required build thickness. Tether agents give an expanded time window for subsequent application of tie coat, ranging from 24 hrs to longer, thus providing application options. An additional advantage includes not requiring a reactivation by spraying an “activating” coat of epoxy or other epoxy mist coats.

### Cure Times

The compositions of the invention are capable of being layered upon each layer achieving a “dry tack” stage, assessed, for example, by pressing the back of a finger onto the epoxy and removing the finger with no epoxy paint adhering to the finger. Alternatively, each layer may be cured for up to several days prior to application of a second layer. In most cases, composition layers are allowed to cure within 24 hours of application.

### Coat Thicknesses

The compositions of the invention can be applied at varying thicknesses. Each coat may be applied by hand or by using airless or other appropriate spraying equipment and applied according to the preference of the applicator. In general each coat will be applied at a wet-film thickness of about 2 to about 30 mils, preferrably about 4 to about 25 mils, more preferably about 6 to about 20 mils. Furthermore, the epoxy layers are generally applied at a well-film thickness of about 2 to about 12 mils, preferably about 4 to about 10 mils, more preferably about 6 to about 9 mils. Fouling release tie coat and surface coat layers are generally applied at a wet-film thickness of about 10 to about 30 mils, preferably about 13 to about 25 mils, more preferably about 16 to about 20 mils. Most preferably, the tie coat will be applied at a wet-film thickness of from about 12 to about 14 mils and the surface coat will be applied at a wet-film thickness of from about 16 to about 20 mils.

Total fouling release system wet-film thicknesses of the present invention, including the two epoxy layers, is generally from about 8 to about 90 mils, preferably about 9 to about 75 mils, and more preferably about 20 to about 60 mils.

### Other Advantages

The tie coat systems and coatings of the invention provide advantages over fouling release coatings including, increased durability; environmentally friendly (no heavy metals or biocides); environmentally safe (VOC compliant, waste disposal in sanitary landfills, no EPA reporting under FIFRA); ease of application (using conventional airless spray line using silicone spray); maintenance savings (eliminates labor intensive scraping, cleaning process streamlined); superior release (removal by water jet with normal pressure or self-cleaning with constant water flow of as low as 7 ft per second); efficient release (speeds as low as 12 knots or as low as 8 knots); fuel savings (from about 6% to about 10%); 3-5 year longevity or greater depending on operational temperatures (reduces dry dock time by half as current coatings lose effectiveness in 18 months).

### EXAMPLES

In order that the invention may be more fully understood, the following examples are provided. It should be understood that these examples are for illustrative purposes only and are not to be construed as limiting the invention in any way. Thus, the invention is further described by way of the following non-limiting examples.

### Analytical Methods

The following methods may be used to characterize the structures of the various embodiments of this invention and their effect on fouling material and the adherence other pollutants to various substrates.

### Size Exclusion Chromatography or Gel Permeation Chromatography

Molecular weights and polydispersities of the tie coat were determined by SEC/GPC in tetrahydrofuran at 30° C., using tetrahydrofuran as the mobile base. Calibration was carried out using linear polystyrenes as standards.

### Viscosity

Viscosity of the tie coat resin was measured using a Brookfield RTV viscometer and large spindles.

### Physical Appearance

Polymers of the invention can be identified using physical appearance such as color and transparency. One of skill in the art will readily be able to recognize differences in physical appearance between samples and standards and will be able to apply this information for identification purposes.

### Elemental Analysis

Elemental analysis was carried out by Galbraith Laboratories, Knoxville, Tenn.

### Peel Test Analysis

Peel tests provide a measure of the strength (energy) of adhesion between the various layers in the system. They are described here for measuring the strength of adhesion between the second epoxy layer (containing the tethering agent) and the tie coat. A five inch wide strip of nylon mesh (type used for dry wall) was imbedded at the interface between the second epoxy layer and the tie coat, by placing the mesh on the tacky epoxy layer and then painting the tie coat and subsequently the top coat over top of it. An eight inch length of the mesh strip was left protruding from the interface and over the edge of the tile form gripping in the pull tests.

The tile is clamped to the base of an Instron tensile testing machine and the strip of mesh, reinforced with duct tape and clamps, is pulled upward by an Instron. The Instron simultaneously measures the force exerted and the distance pulled. Integration of the area under the force vs. displacement curve divided by the area of the mesh strip gives the interfacial energy per unit area, which is the figure of merit determined by the test.

The table below shows the Energy/Area (E/A) results in units of J/m² for all the tests performed. For each set of samples, the average E/A value and the standard deviation were calculated.

TABLE
Tabulated Pull Test Results

| | | Average | | | | | | | |
|---|---|---|---|---|---|---|---|---|---|
| | | Energy/Area | Std. | Individual Pull Test Results | | | | | |
| Sample Description | # | (J/m\hat{ }2) | Dev. | E/A | E/A | E/A | E/A | E/A | E/A |
| 30% SCM 501C | 1 | 548 | 142 | 750 | 442 | 543 | 455 | | |
| 15% SCM 501C | 2 | 524 | 95 | 657 | 527 | 550 | 496 | 393 | |
| 5% SCM 501C | 3 | 347 | 39 | 407 | 382 | 341 | 325 | 321 | 308 |
| 1% aminopropyltriethoxysilane | 6 | 417 | 89 | 438 | 494 | 320 | | | |
| 1% aminopropyltrimethoxysilane | 9 | 453 | 118 | 619 | 440 | 440 | 327 | 561 | 333 |
| 1% methylaminopropyltrimethoxysilane | 12 | 364 | 61 | 386 | 295 | 338 | 436 | | |
| 1% cyclohexylaminopropyltrimethoxysilane | 15 | 383 | 52 | 389 | 373 | 321 | 449 | | |
| 1% N-phenylaminopropyltrimethoxysilane | 18 | 647 | 311 | 675 | 943 | 323 | | | |

Samples 1 and 2 with 30% and 15% SCM 501C respectively preformed very well and were statistically indistinguishable. Sample 3 with 5% SCM 501C had a lower interfacial energy, i.e. performed less well by a statistically significant margin.

Of the alternative tethering additives sample 6 (1% aminopropyltriethoxysilane) and sample 9 (1% aminopropyltrimethoxysilane) produced the best results and to within the error of the experiments were the same as samples 1 and 2 (30% and 15% 501C). The alternative agents of samples 12 and 15 did not perform as well. The alternative tethering agent of Sample 18 produced the highest energy/area result but only three samples were successfully tested and the error for this set of data is very high. Thus it is difficult to draw conclusions for sample 18.

### Fouling Material—Visual Inspection

Test areas can be coated with fouling release systems of the invention and compared against untreated test areas using visual inspection. Areas which can be tested include, but are not limited to, concrete pipe, or other material exposed to moving sea water, fiberglass plates placed in stagnant sea water, and other substrate materials placed on the water exposed hull of a vessel and passed through water. Visual inspection can occur after varied periods of time or using various speeds of water as can be readily varied by one of skill in the art.

The following examples are given by way of illustration only and are not to be considered limitations of this invention or many apparent variations of which are possible without departing from the spirit or scope thereof.

### Surface Roughness Analysis

Atomic Force Microscopy (AFM) is a technique in which a very fine stylus tip is passed over a sample surface to measure it topography. This technique can make topographic images of surface roughness and can provide average measurements of surface roughness. Two numbers are quoted, Z-range and RMS. Z-range is the vertical distance from the highest to lowest point on the surface in the region scanned. RMS is the root-mean-square average roughness over the whole image. AFM testing showed the duplex foul release system to have a Z-range of from about 0.5 microns to about 70 microns, and more preferably about 1.2 microns and an rms roughness range of from about 40 nm to about 1 micron and more preferably about 80 nm.

### Example 1

### Synthesis of a Polysiloxane-Based In-Situ Polymer Blend

The blend reactions are carried out in a fume hood using a 3 neck round bottom flask equipped with a condenser and a mechanical stirrer and is purged continuously with nitrogen. For example, 32 mL hydroxy terminated polydimethylsiloxane having a viscosity of 8,000 cSt at 25° C. and 0.386 g of benzoyl peroxide are added to the reactor and the mixture is stirred vigorously for 20 minutes. 12.3 mL styrene and 35.4 mL n butyl acrylate are added to the reactor and the mixture is stirred continuously for 20 minutes. 20 mL deionized water is added and the system is stirred for 20 minutes. The reactor is then immersed in a water bath having a temperature of 100° C. The color changes to pale white within 10 minutes, and the color and viscosity increases continuously throughout the reaction. After 2-3 hours, the reaction is completed. The condenser is removed during the last 15 minutes in order to strip off most of the water. The white viscous polymer is collected and further dried in a vacuum oven.

### Example 2

### Synthesis of a Polysiloxane-Based In-Situ Polymer Blend

The reaction is carried out as above but 32 mL of a hydroxy-terminated polysiloxane having a viscosity of 20,000 CSt at 25° C. is used with 18.5 mL of styrene, 52.6 mL of n-butyl acrylate, 0.836 g benzoyl peroxide, and 20 mL of deionized water. Examples 1 and 2 can be carried out in various solvents including, but not limited to toluene, ether, tetrahydrofuran (THF), benzene, dichloromethane, and hexanes. The viscosities of polysiloxanes can range from between about 10 to about 100 cSt at 25° C., about 2000 to about 8000 cSt at 25° C., and about 10,000 to about 50,000 cSt at 25° C. In certain embodiments, the viscosity of the polysiloxane is 3500 cSt. Additionally, initiators include but are not limited to benzoyl peroxide, di-t-butylperoxide, cumene hydroperoxide, t-butyl hydroperoxide, AIBN, azo-bis-alkylnitrile and ditert-butyl peroxide.

### Example 3

### Exemplary Tie Coat & Top Coat Formulation

An exemplary formulation of Tie Coat and Top Coat as described herein are shown, without limitation, in Table 2 below. In each coat, the materials are divided into two parts (A & B) prior to mixing.

TABLE 2
Tie Coat & Top coat formulations (A and B
formulations in Metric Units)

| | Component | 1000 ml | 500 ml | 250 ml | 100 ml |
|---|---|---|---|---|---|
| Tie Coat | | | | | |
| A | TieCoat Resin | 444.622 | 222.311 | 111.156 | 44.462 |
| | Hexane | 244.422 | 122.211 | 61.106 | 24.442 |
| | SF-69 | 110.955 | 55.478 | 27.739 | 11.096 |
| | Total A | 800.000 | 400.000 | 200.000 | 80.000 |
| B | CA-40 | 110.955 | 55.478 | 27.739 | 11.096 |
| | Hexane | 88.844 | 44.422 | 22.211 | 8.884 |
| | GF-91 | 0.200 | 0.100 | 0.050 | 0.020 |
| | Total B | 200.000 | 100.000 | 50.000 | 20.000 |
| | Tie Total A + B | 1000.000 | 500.000 | 250.000 | 100.000 |
| Top Coat | | | | | |
| A | RTV-11 | 766.871 | 383.436 | 191.718 | 76.687 |
| | SF-1147 | 92.025 | 46.012 | 23.006 | 9.202 |
| | Naptha | 69.018 | 34.509 | 17.255 | 6.902 |
| | Total A | 927.914 | 463.957 | 231.979 | 92.791 |
| B | DBT | 3.067 | 1.534 | 0.767 | 0.307 |
| | Naptha | 69.018 | 34.509 | 17.255 | 6.902 |
| | Total B | 72.086 | 36.043 | 18.021 | 7.209 |
| | Top Total A + B | 1000.000 | 500.000 | 250.000 | 100.000 |

### Example 4

### Application of a Duplex Tie Coat to a Water Delivery Tunnel

This example describes the application of a duplex fouling release system of the invention to a concrete surface, which is a test patch in a tunnel that is used to bring cooling water from the sea to a power plant.

The concrete is sealed with Americoat Amerlock two part epoxy concrete sealer. The sealer is rolled on with a ¼ inch nap roller. Conditions for the sealer application: T=60° C., 60% relative humidity. Eighteen hours after sealing the concrete surface, a coating of white, two part epoxy Amerlock 400 marine paint is applied to the surface with a ¼ inch nap roller. The anticorrosive epoxy marine paint is allowed to cure for 24 hours.

The toughening tie layer resin is prepared as follows. 2 liters of the reactively stabilized organopolysiloxane blend prepared according to Example 1 and 1.5 liters of hexane are mixed until the viscosity of the organopolysiloxane is reduced considerably. After 10 minutes, 500 ml of Wacker CA40, a curing agent, is added and the material is mixed. The tie coat is applied to the surface with a ¼ inch nap roller. The release layer is applied over the tie layer about two hours after the tie layer application is complete. Four liters of Momomentive Performance Materials RTV-11 silicone release layer material is mixed with a tin based catalyst, and is applied immediately.

The application is allowed to cure for two days before the tunnel is re-flooded with sea water. The tunnel is periodically drained and the test patches are inspected. The test patches are found to be free of the marine fouling organisms, which infested the rest of the tunnel surface. The coating is in excellent physical condition at each inspection at year two and year three.

### Example 5

### Application of a Monoplex Tie Coat to a Water Delivery Tunnel

This example describes the application of a monoplex fouling release system of the invention to a concrete surface, which is a test patch in a tunnel used to bring cooling water from the sea to a power plant.

The concrete is sealed with Americoat Amerlock two part epoxy concrete sealer. The sealer is rolled on with a ¼ inch nap roller. Conditions for the sealer application: T=60° C., 60% relative humidity. Eighteen hours after sealing the concrete surface, a coating of white, two part epoxy Amerlock 400 marine paint is applied to the surface with a ¼ inch nap roller. The anticorrosive epoxy marine paint is allowed to cure for 24 hours.

The mixed toughening tie layer/surface coat resin is prepared as follows. 4 liters of the reactively stabilized organopolysiloxane blend prepared according to Example 1 and 1.5 liters of hexane are mixed until the viscosity of the organopolysiloxane is reduced considerably. One liter of Momentive Performance Materials RTV-11 silicone release layer material is further added and is stirred for 10 minutes. After 10 minutes, 500 ml of Wacker CA40, a curing agent, is added and the material is mixed. CA40 can be used to cure both components of the monoplex. Alternatively DBT (a surface coat curing agent) also works to cure both components of the monoplex. In certain embodiments, the system is a somewhat better when cured with DBT. The tie layer/surface coat resin is applied to the surface with a pressurized spray dispenser.

The application is allowed to cure for two days before the tunnel is re-flooded with sea water. The tunnel is periodically drained and the test patches are inspected.

### Example 6

### Method of Coating a Surface with the Tie Coat of the Invention

Prior to coating a surface, the following preparations should be made: test patch or full coating system; visit site, check condition of item to be painted, verify substrate is wood, steel, fiberglass or if surface prep is complete or if any repairs are required; review containment or ventilation requirements; review if pressure wash, abrasive blast, or soda blast is required; verify square footage and estimate quantity of paint needed; determine whether special access requirements are needed; record equipment and materials needed; list test equipment required and check operation, will test panels be coated also; paint pumps epoxy, tie coat, surface coat; determine sufficient spray line, spray guns, tips and spare parts; check schedule to be sure sufficient dry and recoat times; check weather forecast; check if paint is on site, check quantities and batch numbers; discuss application schedule with applicator; and separate dedicated spray pumps and lines used for epoxy, tie and surface coats.

On Day 1, check ambient conditions (temp, dew point, humidity, surface temp and forecast. Record data on application form. Check adjacent areas for potential overspray problems. Tape off surface areas not to be coated. Set-up equipment. Run airlines and layout paint lines. Stage paint and thinners for coat to be applied. Determine if repairs are complete (concrete may require sealer). Determine if surface is clean and ready to accept coating (solvent wipe, blow down). Be sure to have adequate solvents to clean pump, spray lines and gun. Mix epoxy coating 1 materials as recommended by manufacturer, check viscosity as needed. Stripe coat as needed (sharp edges, corners, tight areas). Apply coating, check wft (wet film thickness), apply even pattern and cross. Brush or roll out runs, sags. Touch-up holidays.

Clean spray equipment immediately. Check coating at recommended dry/re-coat times. Take and record dry film thickness measurements. (5-7 mils) Use plastic shim if coating is somewhat soft (be sure to subtract shim thickness from measurement. If coating is dry to touch proceed with next coat if ambient conditions are acceptable. For Coat 2 (epoxy-tethering agent) mix proper amount of tethering agent with epoxy. Completely mix components and allow 10-15 minutes sweat in time prior to application. Check surface to be coated for cleanliness (visual). Clean as needed. Apply coating as on previous coat. Dry re-coat times may increase due to addition of tethering agent. Check wet film measurements. Brush out runs, sags as work progresses, touch-up holidays. Clean equipment. First and second coat of epoxy can generally be applied in the same day. If Tie coat can not be applied the next day, apply an additional epoxy coat with tethering agent.

On Day 2, check and record ambient conditions, check coating cure, check surface cleanliness (visual). Set-up equipment. Stage coating materials. For the Tie Coat, mix tie coat components, check viscosity of coating with viscosity cup and stopwatch (generally 20-25 seconds with #5 Zahn cup). Thinning not needed for this coat. Stripe coat sharp edges, corners and tight areas with spray as you go along. Check wet film thickness to gage how many passes are needed (10-14 dft). Check for and touch-up holidays as needed. Lightly brush out runs, sags as they occur. Clean-up spray pump, lines and spray gun immediately. Do not allow coating to set up in spray lines. Coating will cure faster at higher temperatures.

Allow 1-2 hours dry time prior to Surface coat application. Coating should be dry to touch prior to Surface coat application. Check and record ambient conditions. Check surface cleanliness (visual). Check and record tie coat dry film thickness measurements. (use plastic shim method). Set-up equipment. Stage coating materials. For Surface coat, pre-mix part A surface coat. Add thinner as needed to achieve 40-45 seconds #5 Zahn cup. Approximately 15%. Add part B (hardener) after proper viscosity is achieved. Stripe coat sharp edges, corners and tight areas with spray as you go along. Lightly brush out sags, runs as they occur. High ambient temperatures will speed up cure times. Check wet film thickness to gage how many passes are needed (12-14 dft). Clean spray pump, lines, spray gun immediately. Do not allow coating to set up in spray lines. Collect all paint waste for proper disposal.

Allow coating to cure 1 day minimum prior to removing masking materials. Lightly cut along tape line prior to removal. Do not cut into substrate. Allow adequate dry time (2 days) before moving jack stands. Touch-up jack stand locations using full four coat system. Solvent wipe substrate if needed. Surface coat by spray is preferred. It is preferred to step coatings around stands as they are applied. Epoxy, epoxy+tethering agent, and tie coat should be applied up to existing coatings and not overlap. Surface coat should overlap existing surface coat slightly.

### Example 7

### Application

### Duplex Fouling Release System, Full Hull Application, Spray Application

### Vessel: Hinckley Picnic Boat—Length: 36 Feet, Beam: 12 Feet

The Duplex Fouling Release System (DFRS) is applied to a Hinckley 36 foot Picnic Boat. This is a pleasure yacht powered by a Water Jet engine. The hull is composed of carbon fiber/kevlar/epoxy/e-glass composite. This vessel undergoes a sea trial to measure performance on the existing copper ablative antifouling bottom prior to stripping the copper ablative paint and installing the Duplex Fouling Release System. The hulls maximum attainable speed prior to coating with the DFRS is about 27.4 knots on the two month old copper bottom.

The DFRS is applied using standard spray application techniques well know by those practiced in the art of marine paint application. The application is as follows:

The vessel is hauled and positioned in an outdoor protected shipyard space and is supported on the keel and is held upright by three jack stands each port and starboard. All layers of the DFRS are applied with airless spray equipment using a cross-hatched application spray technique as described herein.

The copper ablative bottom paint is removed using a grit blast of baking soda. The bottom up to the waterline is clean down to the composite surface.

The first layer of epoxy is applied on day 1 of DFRS installation. The weather is clear and dry, temperature is in the high 70° F. low 80° F. range and humidity is approximately 50%. The first layer of epoxy is comprised of Sea Guard 5000 from Sherwin Williams. This layer is applied with a 36:1 airless sprayer (Graco) operating at 60 psi. The first coat of epoxy is applied (8 to 9 mil wet film thickness) in approximately 15 minutes and is allowed to dry to a dry tack, taking approximately 4 hours to reach the reapplication state.

The second layer of epoxy is comprised of Sea Guard 5000 from Sherwin Williams and contains about 15% by volume of SCM501C from Momentive Performance Materials, Inc. This layer is applied with the same 36:1 airless sprayer (Graco) operating at the same pressure. This layer of epoxy is applied in approximately 15 minutes (8 to 9 mil wet film thickness) and is left overnight before the application of the DFRS Tie Coat the following morning. Note: This second layer of epoxy may be allowed to reach a dry tack state, approximately 4 hours before the application of the Tie Coat. In this application, the Tie Coat is applied the following day for applicators convenience.

The Tie Coat is applied on day 2 of the DFRS installation. The weather is clear and dry, temperature was in the high 70° F. low 80° F. range and humidity is approximately 50%. This layer is applied with a 54:1 airless sprayer (Graco) operating at approximately 60 psi. The Tie Coat is applied in approximately 15 minutes and is allowed to dry to a dry tack, taking approximately 1.5 hours to reach the reapplication state.

The Surface Coat is applied on day 2 of the DFRS installation once the Tie Coat achieves the dry tack state. This layer is applied with a 54:1 airless sprayer (Graco) operating at approximately 75 psi. The Surface Coat is applied in approximately 15 minutes.

Two days following the application of the Surface Coat, the jack stands are moved so that untreated areas covered by the original placement of the jack stands are coated using the DFRS Repair System. The repair system was applied as follows:

a. Sea Guard 5000 marine epoxy is hand applied to the clean sections of the hull using a brush application. This first coat of epoxy is applied to a wet film thickness of approximately 9 mils and is allowed to proceed to a dryness of a dry tack. Drying time is approximately 3 hours.

b. Sea Guard 5000 containing 15% SCM501C is hand applied to the first coat of epoxy (described in section (a) above). This second coat of epoxy is applied to a wet film thickness of approximately 9 mils and is allowed to proceed to a dryness of a dry tack. Drying time is approximately 3 hours.

c. The DFRS Tie Coat is hand applied to the second coat of epoxy using a brush application. This Tie Coat is applied to a wet film thickness of approximately 16 mils and is allowed to proceed to a dryness of a dry tack. Drying time is approximately 1.5 hours.

d. The DFRS Surface Coat is hand applied to the surface of the Tie Coat using a brush application. This Surface Coat is applied to a wet film thickness of approximately 18 mils and is allowed to proceed to dryness.

The Hinckley Picnic Boat with the DFRS installed is launched two days following the application of the Repair Kit.

The Hinckley Picnic Boat with the Duplex Fouling Release System installed is subjected to a sea trial following the launch of the vessel. The vessel remains free of hard fouling in the Chesapeake Bay for a 30 day period during the months of June and July, 2007. This is a season of extremely high biofouling where vessels with copper ablative coatings are seeing hard fouling over the same period of time. Additionally, the Hinckley Picnic Boat repeatedly achieves a speed of 30.5 knots following the application of the DFRS. This is about an 11.3% improvement in hull speed compared to a new copper ablative coating.

### Example 8

### Application

### Duplex Fouling Release System with Mist Coat, Trial Patch, Hand Application

Vessel: San Juan Jax Bridge Trial: 150 Square Foot Patch (approximately)

The Duplex Fouling Release System (DFRS) is applied to the port bow section, at the water line, of a 700 ft barge that travels at approximately 8 knots. This is a vessel that plies the trade route between Jacksonville, Fla., USA to San Juan, Puerto Rico. The hull is steel. This application is chosen to evaluate the performance of the DFRS on vessels traveling below 12 knots.

The DFRS is applied using standard hand application techniques well know by those practiced in the art of marine paint application. The application is as follows:

The vessel is placed in dry dock prior to extensive repairs including a an application of a standard copper ablative antifouling coating on the entire hull, with the exception of the DFRS Trial Patch, from the water line to the keel. All layers of the DFRS are applied with roller painting technique.

The hull is prepared with grit blast to a standard white finish. The entire DFRS system is applied in a single day.

The first layer of epoxy is applied at approximately 1 PM. The weather is clear and dry, temperature is in the mid 90° F. range and humidity is approximately 85 to 90%. The first layer of epoxy is comprised of Ameron 235 (Ameron Corporation). This first coat of epoxy is applied (8 to 9 mil wet film thickness) in approximately 15 minutes and is allowed to dry to a dry tack, taking approximately 2 hours to reach the reapplication state.

The second layer of epoxy is comprised of Ameron 235 (Ameron Corporation). This layer of epoxy is applied in approximately 15 minutes (8 to 9 mil wet film thickness) and is allowed to dry to a dry tack, taking approximately 2 hours to reach the reapplication state.

The Mist Coat is applied once the second epoxy coat achieves a dry tack state. The Mist Coat is applied in approximately 15 minutes and is allowed to dry to a dry tack, taking approximately 30 minutes to reach the reapplication state.

The Tie Coat is applied once the Mist Coat achieves the dry tack state. The Tie Coat is applied in approximately 15 minutes and is allowed to dry to a dry tack, taking approximately 1 hour to reach the reapplication state.

The Surface coat is applied once the Tie Coat achieves the dry tack state. The Surface Coat is applied in approximately 15 minutes.

The vessel is launched once additional repairs to the hull are completed (more than one week following installation of the DFRS Trial Patch).

The San Juan Jax Bridge with the Duplex Fouling Release System Trial Patch that is installed is inspected several times in the year following the application. Initially following the launch, the vessel spends approximately one month pier side while undergoing additional repairs in Veracruz, Mexico. During this time, hard fouling attaches to the DFRS Trial Patch as expected. Also during this time, the vessel encounters a violent storm while pier side and suffers severe abrasion of the starboard side including the area of the DFRS Trial Patch. Upon inspection one month later in Jacksonville, Fla., it is seen that the DFRS Trial Patch suffered only minor scratching damage while the copper ablative coating on either side of the DFRS Trial Patch is removed down to the steel hull. This demonstrates the extreme resilience of the DFRS to impact damage.

Additionally, following a reciprocal passage of the vessel from Jacksonville, Fla. to San Juan, PR and back, the hard fouling of the DFRS Trial Patch is released simply due to vessel passage. This demonstrates effective fouling release of the DFRS at vessel speeds in the range of about 8 knots. The DFRS Trial Patch remains intact and free of hard fouling in the intervening period of more than a year in service.

### Example 9

### Application

### Duplex Fouling Release System, Trial Patch (200 sq ft approximate), Roller Application by Hand

Vessel: El Moro—Length: 700 Feet, Beam: 60 feet

The Duplex Fouling Release System (DFRS) is applied to an ocean cargo carrier. The hull is composed steel.

All layers of the DFRS are applied using standard hand roller application techniques well know by those practiced in the art of marine paint application. The application is as follows:

The vessel is positioned in an outdoor dry dock.

The copper ablative bottom paint is removed using a grit blast. The bottom up to the waterline is clean down to the steel surface.

The first layer of epoxy is applied on day 1 of DFRS installation. The weather is overcast and dry, temperature is in the 80° F. to 90° F. range and humidity is approximately 70% to 80%. The first layer of epoxy is comprised of Ameron 235 (Ameron Corporation, now PPG, Inc). The first coat of epoxy is applied (8 to 9 mil wet film thickness) in approximately 15 minutes and is allowed to dry to a dry tack, taking approximately 4 hours to reach the reapplication state.

The second layer of epoxy (applied on day 1 once the first epoxy reached the dry tack state) is comprised of Ameron 235 (Ameron Corporation) and contained 15% by volume of SCM501C from Momentive Performance Materials, Inc. This layer of epoxy is applied in approximately 15 minutes (8 to 9 mil wet film thickness) and is left overnight before the application of the DFRS Tie Coat the following morning. Note: This second layer of epoxy may be allowed to reach a dry tack state, approximately 4 hours before the application of the Tie Coat. In this application, the Tie Coat is applied the following day for applicators convenience.

The Tie Coat is applied on the day 2 of the DFRS installation. The weather is clear and dry, temperature is in the 80° F. low 90° F. range and humidity is approximately 80%. The Tie Coat is applied in approximately 15 minutes and is allowed to dry to a dry tack, taking approximately 1.5 hours to reach the reapplication state.

The Surface coat is applied on day 2 of the DFRS installation once the Tie Coat reaches the dry tack state. The Surface Coat is applied in approximately 15 minutes. This vessel is launched several days after the application.

It is recommended that the DFRS once applied is given 3 days to cure prior to launching the vessel.

As of the filing date, the El Moro has not reached an inspection port. There are no comments regarding performance as of the date.

### Example 10

### Power Utility Cooling Water Intake Tunnel Eemshaven, Netherlands

Application: Duplex Fouling Release System with Mist Coat, Trial Patch, Hand Application

The Duplex Fouling Release System (DFRS) is applied to a section of tunnel 6 at the Electrabel Power Generating Station in Eemshaven, Netherlands. This application is chosen to evaluate the performance of the DFRS on concrete coolant unit tunnels utilizing water from the North Sea (cold water environment) and subject to fouling from the Asian Oyster and other hard fouling species from the North Sea. Additionally, this tunnel is subjected to heated water (43° C.) antifouling treatment on a monthly basis during the fouling season.

The DFRS is applied using standard hand application techniques well know by those practiced in the art of marine paint application. The application is as follows:

The tunnel is dewatered and existing fouling organisms are removed by high pressure water wash. All layers of the DFRS are applied with roller painting technique.

The tunnel walls are subjected to a wire brush treatment to remove any loose debris.

A first layer, epoxy concrete sealer, NuKlad 105 (Ameron Corporation) is applied. The environmental conditions in the tunnel at the time of application has a temperature of approximately 60° F. and humidity of approximately 50%. The tunnel walls are dry but there is some residual water on the floor of the tunnel. This first coat of epoxy is applied (8 to 9 mil wet film thickness) in approximately 15 minutes and is allowed to dry overnight.

On the second day of application of the DFRS, a layer of epoxy is applied comprised of Ameron 235 (Ameron Corporation). This layer of epoxy is applied in approximately 15 minutes (8 to 9 mil wet film thickness) and is allowed to dry to a dry tack, taking approximately 3 hours to reach the reapplication state.

The Mist Coat is applied once the second epoxy coat reaches the dry tack state. The Mist Coat is applied in approximately 15 minutes and is allowed to dry to a dry tack, taking approximately 30 minutes to reach the reapplication state.

The Tie Coat is applied once the Mist Coat reaches the dry tack state. The Tie Coat is applied in approximately 15 minutes and is allowed to dry to a dry tack, taking approximately 1 hour to reach the reapplication state.

The Surface coat is applied once the Tie Coat had reached the dry tack state. The Surface Coat was applied in approximately 15 minutes.

The Tunnel is placed back in service approximately one week following the installation of the DFRS.

The DFRS Trial Patch is inspected twice in the three years following installation. The DFRS remains intact and free of hard fouling during this three year period demonstrating no detectable wear and extremely robust protection against fouling with Asian Oysters and other North Sea hard fouling organisms. Additionally, routine treatment with hot water does not diminished the longevity or fouling release properties of the coating. Uncoated portions of the tunnel have extensive fouling throughout, including Asian Oysters up to approximately 6 inches or more in diameter.

### Example 11

### Tile for Zebra Mussell Foul Release Studies

Seventy 20×20 cm by a quarter inch thick ABS plastic tiles are coated with duplex and monoplex antifouling formulations for foul release testing.

1. Duplex System/tin cure/with release oil (standard system).

2. Duplex System/tin cure/with release oil/with pigment.

3. Duplex System/tin cure/without oil.

4. Duplex System/tin cure/without oil/with pigment.

5. Duplex System/no tin/with release oil.

6. Duplex System/no tin/without oil.

7. Monoplex (85% tie/15% top)/tin cure/with release oil.

8. Monoplex (85% tie/15% top)/tin cure/without oil.

9. Monoplex (85% tie/15% top)/no tin/with release oil.

10. Monoplex (85% tie/15% top)/no tin/without oil.

11. Monoplex (95% tie/5% top)/no tin/with release oil.

12. Control/tie coat only/with release oil.

13. Control/tie coat only/without oil.

14. Control/marine epoxy only.

Systems designated “no tin” are cured using CA-40 for both tie and top coats. In systems designated “Monoplex” A specified volume percentage of top coat and tie coat (for instance 85% tie coat material and 15% top coat) was mixed and applied as a single layer to be cured either with the tin catalyst (7 & 8) or with CA-40 (9-11).

The clumping of the tie coat i effectively eliminated by prediluting the CA-40 curing agent in hexane (the same solvent used to dilute the tie coat resin), and by using a power drill driven high shear mixer during the addition of this diluted curing agent to the tie coat resin. The total amount of hexane that is added to the tie coat resin and to the CA-40 prior to mixing these two parts together, is equal in volume to the neat tie coat resin.

Panels are submerged for the summer-fall fouling season for zebra mussels in Burlington Bay, adjacent to Lake Ontario. Evaluation of foul release properties by observation of mussel removal in flowing water up to 10 miles per hour is conducted. The standard duplex system and monoplex formulations both reduces the amount of zebra mussel infestation vs. controls (Samples 12, 13, and 14). Zebra mussels present on the duplex and monoplex panels are easily removed with water flow rates of 10 miles per hour or less. Zebra mussels that are attached to the control samples could not be removed with the maximum water flow rate. The presence of a release oil, SF1147, in the top coat of the duplex or I the monoplex, enhances the effectiveness of the coating by further reducing the amount of zebra mussel infestation and by reducing the speed needed to remove zebra mussels to as low as 2 miles per hour.

### EQUIVALENTS

Those skilled in the art will recognize, or be able to ascertain using no more than routine experimentation, many equivalents of the specific embodiments of the invention described herein. Such equivalents are intended with be encompassed by the following claims. Thus, while the present invention has been described in the context of embodiments and examples, it will be readily apparent to those skilled in the art that other modifications and variations can be made therein without departing from the spirit or scope of the present invention. Accordingly, it is not intended that the present invention be limited to the specifics of the foregoing description of the embodiments and examples, but rather as being limited only by the scope of the invention as defined in the claims appended hereto.

Having described our invention, we claim:

1. A fouling release tie coat polymer blend comprising at least one polysiloxane polymer and one organic polymer wherein said organic polymer is comprised of monomers that polymerize to single chain polymers and wherein said organic polymer is not comprised of crosslinking multifunctional monomers.

2. The tie coat polymer blend of claim 1 wherein the polymer has a weight-average molecular weight of about 50,000 to 500,000.

3. The tie coat polymer blend of claim 1, wherein the polysiloxane polymer has the repeating unit formula 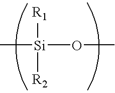
wherein R₁ and R₂ are independently substituted or unsubstituted C₁-C₃ alkyl, or substituted or unsubstituted aryl, each of which may be substituted with cyano, halogen or another group which does not provide another linking functionality.

4. The tie coat polymer blend of claim 3, wherein at least one terminal end of the polysiloxane polymer has at a terminal reactive group.

5. The tie coat polymer blend of claim 4, wherein the terminal reactive group is a hydroxyl group, an alkoxy group, an aryloxy group, an amino group, an amido group, a halogen, or a vinyl group.

6. The tie coat polymer of claim 5, wherein the polysiloxane polymer is hydroxyl terminated polydimethylsiloxane.

7. The tie coat polymer blend of claim 1 further comprising an organic monomer or monomers capable of undergoing free radical polymerization in the presence of in-situ generated free radicals.

8. The tie coat polymer blend of claim 7, wherein the organic polymer is comprised of mono-olefinic monomers.

9. The tie coat polymer blend of claim 8, wherein the mono-olefinic monomers are ethylene monomers, propylene monomers, butene monomers, vinyl chloride monomers, vinyl fluoride monomers, fluoroacrylates, vinyl acetate monomers, styrene monomers, ring substituted styrene monomers, vinylpyrrolidine monomers, vinylnaphthalene monomers, N-vinylcabazole monomers, N-vinylpyrrolidone monomers, acrylic acid monomers, methacrylic acid monomers, acrylonitrile monomers, methacrylonitrile monomers, vinylidine fluoride monomers, vinylidine chloride monomers, acrolein monomers, methacrolein monomers, maleic anydride monomers, stilbene monomers, indene monomers, maleic acid monomers, or fumaric acid monomers.

10. The tie coat polymer blend of claim 9, wherein the organic polymer is comprised of styrene, butylacrylate, other alkylacrylates or a mixture thereof.

11. The tie coat polymer blend of claim 7, wherein the in-situ generated free radicals are initiated by the addition of benzoyl peroxide or di-t-butylperoxide, cumene hydroperoxide, and t-butyl hydroperoxide.

12. The tie coat polymer blend of claim 1, further capable of being atomized and sprayed for application to a surface.

13. The tie coat polymer blend of claim 12, further comprising a silicone fluid capable of increasing the sprayability of the blend.

14. The tie coat polymer of claim 1 further capable of forming an intimate covalent bond matrix with a surface to which it is applied.

15. The tie coat polymer blend of claim 1 having a viscosity of about 40,000 to about 400,000 centipoise at 25° C.

16. The tie coat polymer blend of claim 15, having a viscosity of about 80,000 to about 250,000 centipoise at 25° C.

17. The tie coat polymer blend of claim 16, having a viscosity of about 95,000 to about 150,000 centipoise at 25° C.

18. The tie coat polymer blend of claim 1, which further comprises a curing agent, wherein said curing agent is not a tin-based catalyst.

19. The tie coat polymer blend of claim 18, wherein the curing agent is N,N′,N″-Tricyclohexyl-1-methyl silanetriamine, tin-based, platinum-based, or titanium-based catalysts or other non-tin-based catalysts or an organic-based catalyst.

20. An fouling release system comprising an anticorrosive epoxy layer applied to a substrate, a tie coat polymer blend as described in claim 1 applied to the epoxy layer, and a silicone surface coat applied to said tie coat polymer blend, wherein said epoxy layer comprises a silane coupling agent having primary amines.

21. The fouling release polymer system of claim 20, wherein said tie coat polymer blend further comprises a silicone fluid.

22. The fouling release system of claim 20, wherein the substrate is cleaned before application of the anticorrosive epoxy layer.

23. The fouling release system of claim 22, wherein the substrate is grit-blasted before application of the anticorrosive epoxy layer.

24. The fouling release system of claim 20, wherein the silicone surface coat further comprises a release oil.

25. An fouling release polymer system comprising a first anticorrosive epoxy layer applied to a substrate, a second anticorrosive epoxy layer applied to said first anticorrosive epoxy layer, a tie coat polymer blend as described in claim 1 applied to said second anticorrosive epoxy layer, and a silicone surface coat applied to said tie coat polymer blend, wherein said second anticorrosive epoxy layer further comprises a silane coupling agent having primary and/or secondary amines.

26. The fouling release system of claim 25, wherein said tie coat polymer blend further comprises a silicone fluid.

27. The fouling release system of claim 25, wherein the substrate is cleaned before application of the first anticorrosive epoxy layer.

28. The fouling release system of claim 27, wherein the substrate is grit-blasted before application of the first anticorrosive epoxy layer.

29. The fouling release system of claim 25, wherein the silicone surface coat further comprises a release oil.

30. A fouling release polymer system comprising an anticorrosive epoxy layer applied to a substrate, and a single layer applied to said anticorrosive epoxy layer which performs in one single layer the combined functions of the tie coat and release layer, said single layer comprising a blend of silicone surface coat material and tie coat material as described in claim 1, wherein said anticorrosive epoxy layer further comprises a silane coupling agent comprising primary and/or secondary amines.

31. The fouling release system of claim 30, wherein said tie coat polymer blend further comprises a silicone fluid.

32. The fouling release system of claim 30, wherein the substrate is cleaned before application of the first anticorrosive epoxy layer.

33. The fouling release system of claim 32, wherein the substrate is grit-blasted before application of the first anticorrosive epoxy layer.

34. The fouling release system of claim 30 wherein tie coat polymer blend is about 5% to about 99% by weight of the mixed layer.

35. The fouling release system of claim 34 wherein tie coat polymer blend is about 50% to about 99% by weight of the mixed layer.

36. The fouling release system of claim 35 wherein tie coat polymer blend is about 75% to about 95% by weight of the mixed layer.

37. The fouling release system of claim 30, wherein the silicone surface coat further comprises a release oil.

38. A method for preparing a composition comprising contacting an organopolysiloxane and one organic polymer wherein said organic polymer is comprised of monomers that polymerize to single chain polymers and wherein said organic polymer is not comprised of crosslinking multifunctional monomers.

39. The method of claim 38, further comprising contacting a free-radical initiator with the organopolysiloxane and/or organic polymer.

40. The method of claim 39, wherein the free-radical initiator is an azo-bis-alkylnitrile.

41. The method of claim 40, wherein the free-radical initiator is AIBN.

42. The method of claim 39, wherein the free-radical initiator is a peroxide.

43. The method of claim 42, wherein the free-radical initiator is benzoyl peroxide, di-t-butylperoxide, cumene hydroperoxide, and t-butyl hydroperoxide.

44. The method of claim 38, wherein the polysiloxane polymer has the repeating unit formula 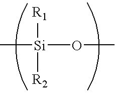
wherein R₁ and R₂ are independently substituted or unsubstituted C1-C3 alkyl, or substituted or unsubstituted aryl, wherein said substituents, if present, are chosen from cyano, halogen or another group which does not provide another linking functionality.

45. The method of claim 38, wherein at least one terminal end of the polysiloxane polymer has a terminal reactive group.

46. The method of claim 45, wherein the terminal reactive group is a hydroxyl group, an alkoxy group, an aryloxy group, an amino group, an amido group, a halogen, or a vinyl group.

47. The method of claim 45, wherein the polysiloxane polymer is hydroxyl terminated polydimethylsiloxane.

48. The method of claim 47, wherein the hydroxyl terminated polydimethylsiloxane is less than 100 centistokes at 25° C.

49. The method of claim 47, wherein the hydroxyl terminated polydimethylsiloxane is between 2000 to 8000 centistokes at 25° C.

50. The method of claim 47, wherein the hydroxyl terminated polydimethylsiloxane is between 10,000 to 50,000 centistokes at 25° C.

51. The method of claim 38, further comprising organic monomer(s) capable of undergoing free radical polymerization in the presence of in-situ generated free radicals.

52. The method of claim 38, wherein the organic polymer is comprised of mono-olefinic monomers.

53. The method of claim 52, wherein the mono-olefinic monomers are ethylene monomers, propylene monomers, butene monomers, vinyl chloride monomers, vinyl fluoride monomers, fluoroacrylates, vinyl acetate monomers, styrene monomers, ring substituted styrene monomers, vinylpyrrolidine monomers, vinylnaphthalene monomers, N-vinylcarbazole monomers, N-vinylpyrrolidone monomers, acrylic acid monomers, methacrylic acid monomers, acrylonitrile monomers, methacrylonitrile monomers, vinylidine fluoride monomers, vinylidine chloride monomers, acrolein monomers, methacrolein monomers, maleic anydride monomers, stilbene monomers, indene monomers, maleic acid monomers, or fumaric acid monomers.

54. The method of claim 38, wherein the organic polymer is styrene, butylacrylate, other alkylacrylates or a mixture thereof.

55. The method of claim 38, wherein the polymer has a weight-average molecular weight of about 50,000 to 500,000.

56. The method of claim 38 or 39 wherein the contacting is performed in a nitrogen sparged atmosphere.

57. The method of claim 38, further comprising contacting with a bifunctional tethering agent.

58. The method of claim 57, wherein the bifunctional tethering agent comprises an amine functionality and a siloxane-like functionality.

59. The method of claim 39, wherein the initiator is introduced to the organopolysiloxane and/or organic polymer in a plurality of doses.

60. The method of claim 39, wherein the initiator is introduced to the organopolysiloxane and/or organic polymer in a single dose.

61. The method of claim 38, further comprising contacting with a curing agent, wherein said curing agent is not a tin-based catalyst.

62. The method of claim 38, wherein the shear rate used during polymerization is from about 10 min⁻¹ to about 1500 min¹.

63. The method of claim 38, wherein the product produced does not possess elongated phase separated or microphase separated polymer morphology.

64. The method of claim 38, further comprising addition of water.

65. A method for preparing a surface having fouling release properties comprising applying a composition of claim 1 to a surface.

66. The method of claim 65, wherein the surface is a substrate comprising an anticorrosive epoxy.

67. A method for preparing a surface having fouling release properties comprising applying a composition of claim 20 to a surface.

68. The method of claim 67, wherein the surface is a substrate comprising an anticorrosive epoxy.

69. A method for preparing a surface according to any of claims 65 or 67 further comprising applying a surface coat.

70. The method of claim 69, wherein the surface coat is a silicone surface coat.

71. A product made by the process of contacting an organopolysiloxane and one organic polymer wherein said organic polymer is comprised of monomers that polymerize to single chain polymers and wherein said organic polymer is not comprised of crosslinking multifunctional monomers and where said organic polymer is prepared by exposure to in-situ generated free radicals in the presence of the polydimethylsiloxane.

72. The product of claim 71, further comprising contacting a free-radical initiator with the organopolysiloxane and organic monomers.

73. The product of claim 71, wherein the contacting is performed in a nitrogen sparged atmosphere.

74. The product of claim 71, wherein the process further comprises the addition of water.

75. The fouling release system of any one of claims 20, 25, or 30, wherein the epoxy coat comprises a tethering agent and the tie coat does not consist of cross-linkers.

76. The fouling release system of any one of claims 20, 25, or 30, wherein the epoxy coat and the tie coat are self assembled.

77. The system of claim 76 wherein the self assembly is caused by silicone-silicone interactions.

78. The fouling release system of any one of claims 20, 25, or 30, wherein the surface coat and the tie coat are self assembled.

79. The system of claim 78 wherein the self assembly is caused by silicone-silicone interactions.
